(19) United States
(12) Patent Application Publication
(10) Pub. No.: US 2002/0165724 A1
(43) Pub. Date: Nov. 7, 2002

(54) Method and system for propagating data changes through data objects

(76) Inventor: Bartus C. Blankesteijn, DD Nijkerk (NL)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 09/791,292

(22) Filed: Feb. 23, 2001

Related U.S. Application Data
(60) Provisional application No. 60/267,022, filed on Feb. 7, 2001.

(51) Int. Cl. G06F 17/60

(52) U.S. Cl. 705/1

(57) ABSTRACT

A method and system are disclosed for propagating data changes from a data change source to a data change destination via a replication mechanism. After receiving a change to a data entry by the data change source, the replication mechanism builds a data change object specifying a first change. After performing optional formatting and filtering operations, the replication mechanism renders the data change object available for transmission to at least the data change destination. The system provides the data change object to the data change destination. In an embodiment of the invention, the data change object is combined with a prior change on the same object to render a “net” change on the data object. The disclosed invention is incorporated by way of example into a database application/system for maintaining business objects such as sales orders, shipping, and other business transactions. However, it is applicable to a variety of data change propagation circumstances including applications running on a same computer system that utilize different data sets having potentially different data formats.

### CROSS-REFERENCE TO RELATED APPLICATION

This application claims benefit of U.S. Provisional Patent Application Serial No. 60/267,022, filed Feb. 7, 2001, the contents of which are expressly incorporated herein by reference in their entirety.

### FIELD OF THE INVENTION

The present invention generally relates to the field of data server systems for maintaining a database of related information in a network environment. More particularly, the present invention concerns methods and apparatuses for propagating changes that are submitted to a database to a number of other systems operating in a variety of potential application environments.

### BACKGROUND OF THE INVENTION

Businesses today rely heavily upon information systems for maintaining records of all aspects of their businesses. Electronic databases store a variety of information concerning business operations. Examples of such information include customer orders, accounts, and shipment status. Other examples of stored data are personnel records and resource allocation data.

An aspect of designing a business data storage system is specifying an architecture/arrangement of the data storage and retrieval system upon which the data is stored. Multi-user data storage and retrieval systems are implemented in a variety of ways. In known mainframe systems, data is stored and retrieved from a database in response to instructions submitted by a set of connected terminals. Users access and manipulate selected portions of a single copy of the data maintained by the database. Such systems experience a significant drop-off in performance when a relatively large number of users seek access to the single copy of the data over slow data links or when the database must perform complex search operations on a large set of data. Business database systems are often called upon to simultaneously serve a large number of simultaneous users as well as perform complex searches on a large set of database entries.

Replicating data from a database onto multiple replicas in many cases improves performance of a database system to which multiple simultaneous accesses are expected. In recent years the advent of low-cost powerful microprocessors and data storage has increased the number of instances where such distributed database system architectures are desired. As a result, new database systems are more commonly distributed with regard to both storage and processing of data. Distributed storage is accomplished by replicating the data onto multiple distributed databases. Distributed processing is facilitated by running separate, integrated, database applications upon the multiple distributed databases. The database applications can be identical or alternatively individually tailored to a particular set of needs of an end user or user group.

In a large corporate business environment, a heterogeneous distributed database system is desirable. The information used by the personnel department differs substantially from the information needs of a sales and marketing department. The same can be said for persons in product development, manufacturing, customer service, etc. Such differing needs concern both the content and the manner in which information is presented to a user. The need for system designers to provide distributed, potentially heterogeneous, data storage and processing systems in turn establishes a need for a database system to efficiently and effectively integrate a database and a set of networked database applications in a distributed database system.

An aspect of integrating a database and distributed database applications that operate upon copies of at least portions of the database is the need to synchronize data. Synchronization includes publishing relevant changes to the database to each of the distributed database applications that maintain data copied from the database. In the case of a homogeneous distributed database, the data is stored in the same format in all the distributed database applications. In the case of heterogeneous systems, the data is represented in a number of differing manners on a set of synchronous distributed databases maintained by applications operating on end systems integrated with a database. Synchronizing heterogeneous distributed database systems is considerably more complex than homogeneous systems since decisions must be made with regard to what data to send and how to send the data to re-synchronize the distributed copies when a database transaction results in a change to the contents of the database. The potential to perform many unneeded data transfers in turn brings to the forefront the need to synchronize distributed data copies efficiently and effectively.

A known method for increasing the efficiency of synchronizing databases is to transmit only changes in the contents of the database when called upon to synchronize a data set with an end system database. Systems potentially benefit from exchanging deltas (differences in the data) instead of exchanging the full set of data regularly. The benefits are most evident in situations where the base data set (previously synchronized) is relatively large, and the number of changes is comparatively small. For example, if a database contains 500,000 production orders, and only 2,000 orders are added or changed per day, then it is wasteful of communication resources to send all (i.e., 500,000) production orders every day from a database that incorporates all the changes to another database/application seeking to synchronize orders. Instead, as disclosed in prior known systems, the changes are communicated to affect synchronization between databases.

Currently systems synchronize changed portions of a database according to differing grouped units of data and/or levels of abstraction/generalization. Such systems, for example, perform synchronization according to physical storage location such as changed sectors or pages. In other systems synchronization occurs according to logical groupings of data such as files, ranges of table entries, columns of data, individual data entries (e.g., a row within a table), and even portions of data entries (e.g., selected columns within a row). In some instances only a portion of a group of related information, presented to a user as a business object, is changed by a database transaction. For example, a new order line added to, or an old line modified within, an order data entry/object does not change other portions of the order data entry/object.

In known applications, the form of data records stored within a database differs from a form in which data, copied from the data records (or portions thereof), is stored in a database seeking to synchronize data content. Furthermore, not all changes to a particular database entry affect business objects or distributed database entries created from the database entry. As mentioned above, when a user runs an application (e.g., BaanERP), a set of changes to database entries initiated by the user's activity often affect only parts of business objects. Thus, other applications, containing data copied from the business objects represented in the database, may only require synchronization with portions of the changed database entries that are unaffected by the changes. Such applications do not require re-synchronization with the set of changes applied to the database entries in the database.

Current known systems utilize either a data-level approach or an application-level approach to integration. Data-level integration is often based on a timestamp mechanism wherein a data entity is marked with its latest change time. However, systems that incorporate the timestamp mechanism do not show the history of the data. Instead, only the current image is available. Another known data-level integration mechanism utilizes an audit trail or log file. This mechanism offers both the before image and the after image for each change. However, other problems arise from this approach. For example, changing a single database row from a source environment can be difficult or even impossible for a target environment to interpret if the data structure differs at the target.

In order to overcome the above-described problems in data-level integration, a second approach is applied—integrating at the application level by integrating the business logic of two or more applications directly or via a user interface. An advantage of application-level integration is that the data exchanged is more high-level. The data is more related to the business process embodied within an application and less to a physical data structure. Furthermore, synchronization can be triggered by application events. However, application-level integration is generally difficult to implement, configure, and maintain—especially if a growing number of applications are to be integrated, or if applications have a short life cycle. Furthermore, in the cases of standard software or legacy applications implementing synchronization at the application level may be virtually impossible.

In view of the problems associated with known data-level and application-level integration, a new form of data change integration mechanism is needed.

### SUMMARY OF THE INVENTION

The present invention offers a new level of integration, by incorporating a method that provides a transition from the data level to the object level. The object is highly configurable, so it can be defined either in terms of the source application or the target application, or by using an intermediate, generic or standardized object structure.

In view of the challenges faced in rendering changes made by a data change source to a data change destination operating in a potentially very different environment, a method and system are claimed for propagating changes to a data entry made by a data change source. In accordance with the present invention, a replication mechanism initially receives a change to a data entry specified by the data change source. The replication mechanism builds a data change object specifying a first change on an identified data construct based upon the change to the database entry. After building the data change object, the data change structure is rendered available for transmission to at least a data change destination. Finally, the replication mechanism provides the data change object to the data change destination.

Minimizing network traffic is a substantial goal in certain embodiments of the present invention. Furthermore, it is not necessary to transmit all changes to a database entry, or other logically grouped set of information treated as a unit for purposes of synchronization, if only the original value and final value are of interest to a system seeking synchronization. Thus, in an embodiment of the present invention, prior to sending the data change objects to a client application, the data change objects are combined to render a net change object that incorporates all related changes. Thereafter, a propagating mechanism sends the final, “net change” to systems seeking synchronization.

The system and method of the present invention, in particular embodiments, incorporate a series of filters. Because building date change objects can consume substantial computing resources, it is important to discard irrelevant changes as soon as possible, thus in an embodiment of the present invention, filters screen out irrelevant changes. Even after the data change objects are created, further filters are, in exemplary embodiments, applied to minimize transmitting irrelevant changes to subscribing client applications.

In accordance with yet another feature of an embodiment of the present invention, the data change objects are rendered in the form of multilevel data objects. Thus, multiple changes upon a complex data object (e.g., a customer purchase order) can be rendered within a single data change object. Embodiments of the invention include for example tuples, and are specified in the form of self-identifying field descriptors such as XML tagged objects.

In an embodiment of the invention, performance is enhanced by preprocessing changes before they are requested by a client application. The receiving step is triggered by completing a transaction affecting the database. In response, the server picks up the change and translates the change into a data change object. When the client application sends a request for all changed business objects since a previous identified request, the net change objects are transmitted without delays associated with determining, formulating, and packaging the data changes for the client application.

### BRIEF DESCRIPTION OF THE DRAWINGS

The appended claims set forth the features of the present invention with particularity. The invention, together with its objects and advantages, may be best understood from the following detailed description taken in conjunction with the accompanying drawings of which:

FIG. 1 is a schematic block diagram depicting primary components of an exemplary data change propagation server system architecture incorporating the present invention;

FIG. 2 is a schematic/process flow diagram summarizing the physical components and process flow steps of an exemplary embodiment of the present invention;

FIG. 3 is a timing diagram depicting the data object correction mechanism;

FIG. 4 is a schematic block diagram depicting the primary components and interfaces of a net change server system embodying the present invention;

FIG. 5 depicts the hierarchy of a server object of an embodiment of the present invention;

FIG. 6 is an attribute list for servers;

FIG. 7 is an attribute list for server runs;

FIG. 8 is an attribute list for processing log;

FIG. 9 is a list of server API methods associated with a net change server system embodying the present invention;

FIG. 10 depicts the hierarchy of a store object and a subscription object of an embodiment of the present invention;

FIG. 11 is an attribute list for stores;

FIG. 12 is an attribute list for periods;

FIG. 13 is an attribute list for changes;

FIG. 14 is a list of store API methods associated with a net change server system embodying the present invention;

FIG. 15 is a list of subscription attributes;

FIG. 16 is a list of stores by subscription attributes;

FIG. 17 is a list of request attributes;

FIG. 18 is a list of request run attributes;

FIG. 19 is a list of retrieve API methods associated with a net change server system embodying the present invention;

FIG. 20 is a list of purge API methods associated with a net change server system embodying the present invention; and

FIG. 21 is a spread sheet summarizing the rules for merging a first and second data change object to render a net change object in accordance with an embodiment of the present invention.

### DETAILED DESCRIPTION OF AN ILLUSTRATIVE EMBODIMENT

A new method for updating data for a target in accordance with changes to source data objects, such as, for example business objects within a database, is described. As used herein a “business object” is a representation of the nature and behavior of a real world thing or concept relating to carrying out a business venture. The business objects represent the things or concepts in terms that are meaningful to a business. Examples of things and concepts represented by business objects include: customers, products, orders, employees, trades, financial instruments, shipping containers and vehicles. In contrast to known data change propagation systems that transmit database transactions or complete copies of a changed data object, changes to source data are propagated in the form of “data change objects” that define changes to a data object. Data change objects are built by a data change server based upon a change to a database entry submitted, by way of example, in a database transaction. Data change objects define one or more actions executed upon a data object in accordance with the submitted change. Although in an embodiment of the invention described herein, a data change server is triggered by a change in persistent data such as for example data stored in a database, in an alternative embodiment of the invention the data changes may simply arise from changes in volatile data. An example of such volatile data is data stored within computer memory associated with an active (presently running) application.

In accordance with an embodiment of the present invention, when a business object changes as a result of a database transaction, the change is combined with other changes to the business object to render a net change on the business object. The change server then makes the net change available to a client application. When an end user application seeks to synchronize data with the database, the changes are transmitted to the end user application—unchanged data is not transmitted to the end user unless requested or needed to fulfill a configured specification. Furthermore, the disclosed embodiment of the invention defines at least changes to business objects in accordance with a self-defining set of field descriptors such as, for example, extensible markup language (XML) tags.

In an embodiment of the present invention a net change server, an example of a replication mechanism embodying the present invention, creates a data “store” structure containing either changes and/or net changes. An application program interface associated with the store provides an interface for client applications to retrieve data via a “pull” mechanism. The propagation interface also supports such replication mechanisms as publication to one or more subscriber client applications and broadcast to all listeners. In general, the present invention is not limited to any particular form of communicating the data change objects to client applications.

The net change server's utility is not limited to synchronizing remote database entities associated with client applications in response to database transactions submitted by a data change source. The net change server also facilitates on-line migration to alternative database systems and other tasks involving replicating database content. An exemplary system for carrying out the present invention is BaanERP. However, a data change server embodying the present invention can also be incorporated into a wide variety other applications that incorporate a data that is shared/replicated across multiple applications.

A data change system embodying the present invention includes a number of additional features that enhance the utility and value of the data change system. The exemplary embodiment exchanges net changes instead of replicating all data changes to reduce network traffic while rendering synchronized data replicas. In a system providing net changes, if the same data object is changed more than once, then the multiple changes are combined and only a single “net” change object is provided for transmission to client applications. Furthermore, the data change system applies filters to database transactions, to limit propagating changes to the ones that might be relevant to client applications. The data change server commences processing changes when they are received rather than waiting for a request for changes by a client application. Therefore, when a request is received, the requested data changes are typically available for transmission to the client application. The data change server represents a flexible, configurable data change propagation mechanism that supports a variety of user/client applications that store data in a variety of distinct formats.

Before describing a set of figures illustratively depicting preferred and exemplary embodiments of the present invention, a set of definitions are provided for terms used herein. Certain acronyms and abbreviations are also explained.

After Image: The status of a data entity or a data object as it is after a change or a series of changes. See also Before Image.

API: Application Programming Interface. A set of methods that can be invoked by other applications. An application's API enables other programs to retrieve data or to carry out functionality of that application.

Audit: To create an audit trail that traces all activities that affect a piece of information, such as a data record, from the time it is entered into a database to the time it is removed.

Audit is also short for “audit trail.”

Audit trail: A means of tracing all activities that affect a piece of information, such as a data record, from the time it is entered into a database to the time it is removed.

Before Image: The status of a data entity or a data object as it was before a change or a series of changes. See also After Image.

BOI: Business Object Interface. An interface to retrieve or update a business object stored in a database.

Change: The creation, update, deletion or any other modification act performed upon an entity in a database. Creating a new sales order and adding or deleting order lines comprise exemplary changes to a sales database.

Client: A user, program or system that requests the execution of a specific task from another program or system. See also Server. In this application, the client usually refers to an application that makes use of the retrieve interface of a store functionality of the data change server system, like the BOI NetList implementation. Note that this client is in turn a server again for an external “client” application.

Data Warehouse: A database, often remote, containing recent snapshots of corporate data. Planners and researchers can use this database freely without worrying about slowing down day-to-day operations of the OLTP database.

DBMS: Database Management System. A software interface between a database and application software. A database management system handles user requests for database actions and allows for control of security and data integrity requirements.

ERP: Enterprise Resource Planning. Any software system designed to support and automate business processes. This may include manufacturing, distribution, personnel, project management, payroll, and financials.

Log: To create a record of transactions or activities that take place on a computer system. A record of transactions or activities that take place on a computer system.

Net Change: A combination of multiple changes on the same entity (e.g., business object). Two updates on the same data are combined into a single update. When adding an entity and then updating it, the net change is a new entity (with regard to a prior version of the entity stored on a client application). When adding an entity and then removing it again, the net change is empty (null/no change). For example a net change combines: creating a sales order, adding two order lines, updating the order header, updating the first order line, and deleting the second order line. The net change is a new sales order having the first order line.

Net List: A method/means of the Business Object Interface to retrieve the net changes (or alternatively merely the changes) on a business object since the last time the NetList function was invoked.

Near real time: Actions are taken (e.g., net changes are formulated) on the fly as the data change server becomes aware of changes submitted to a database. This contrasts to waiting for a client application to request an update before commencing processing changes. As a result of near real time processing, when a client application asks for net changes on a database, the changes are presented without data change processing delays.

OLAP: On-line analytical processing; fast, interactive analysis of shared multidimensional information. Its objective is to analyze relationships in corporate data and look for patterns, trends, and exceptions, in order to make better decisions. OLAP software often makes use of a data warehouse (q.v.).

OLTP: On-line transaction processing. This comprises any processing by an application that results in changes to the database.

SCS: Supply Chain Solutions: A product family of supply chain applications and advanced planning applications. Such applications require integration with ERP applications.

Server: A program or system that performs a predefined task at request of a user or another program or system commonly referred to as a “client.” See also Client.

Transaction: A logical unit of work resulting in one or more changes on a database being executed as an atomic entity.

Transaction notification: A message stating that the data in the source database changed.

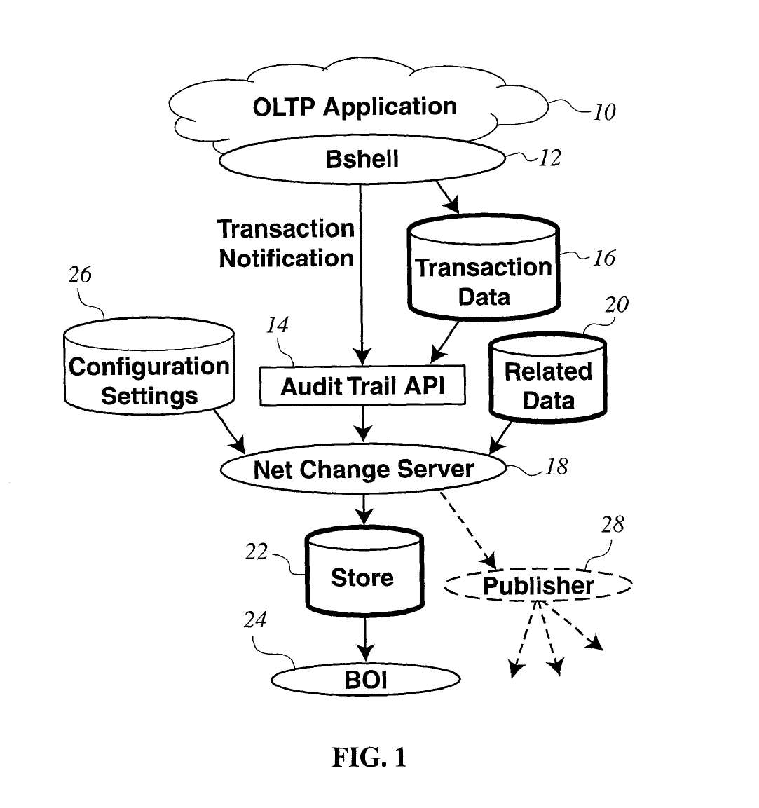

Having generally described features of an embodiment of the invention and having defined a set of terms used herein, attention is now directed to FIG. 1. FIG. 1 is a schematic diagram depicting primary components in a data change server system that incorporates a change server that embodies and carries out the present invention. The change server system is intended to be used, by way of example, in conjunction with sources of database changes such as an OLTP Application 10. The database changes, by way of example, comprise database transactions inserting, deleting and/or updating one or more sales orders and/or one or more order lines. A Bshell 12 is, by way of example, the runtime environment in which the application logic is executed. The Bshell 12 transfers the transaction data, including database change requests initiated by the OLTP application, to a transaction data storage 16. The transaction data represents changes committed to a database (not shown). The Bshell 12 submits corresponding transaction notifications to an audit trail API 14. In response to the transaction notifications, the audit trail API 14 retrieves the corresponding transaction data from the transaction data storage 16. The audit trail API 14, by means of any of a variety of notification/propagation mechanisms, presents the transaction data received from the transaction data storage 16 to a net change server 18. Such transaction notification components are well known to those skilled in the art.

The net change server 18 collects the changes (bundled as transaction units) passed through the Audit Trail API 14, reads supplemental information regarding the changes from related data 20 that (if needed), builds a one or more data change objects based upon the collected changes, and performs any desired/required transformations upon the data change objects to render data change objects specifying an action upon a data object and having a format/content expected by client applications. In the exemplary embodiment of the invention, the data change objects represent/specify changes executed on business objects.

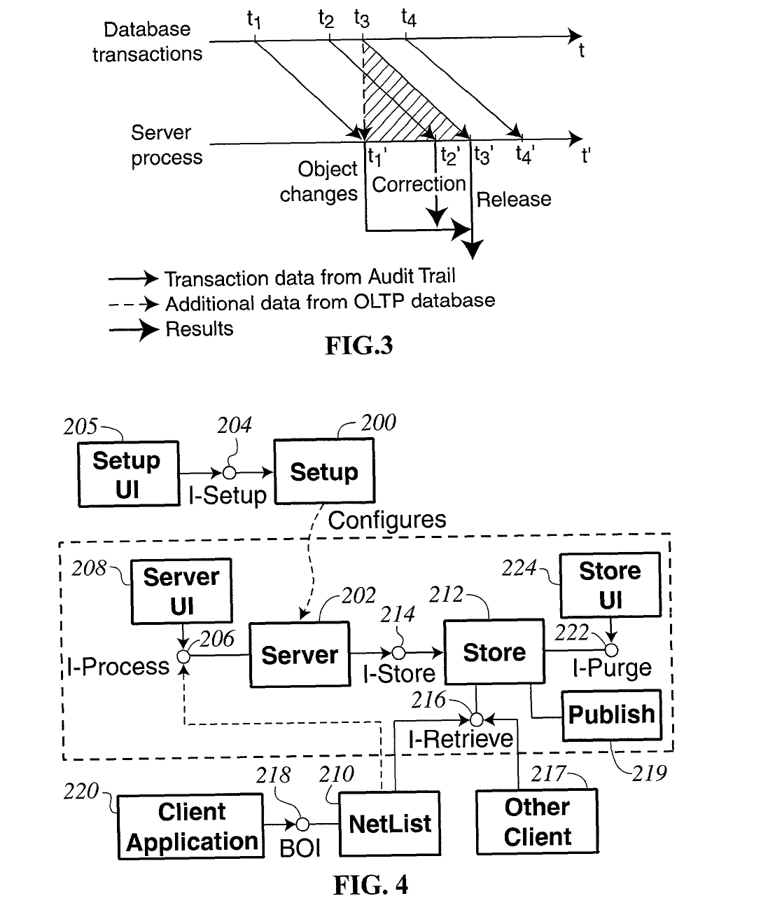

A number of features are preferably incorporated into the net change server to ensure reliable operation. First, the net change server 18 preferably runs in near real-time. When an elapsed time between committing an OLTP transaction to a database and processing the transaction by the net change server 18 increases, the risk that the net change server 18 will not be able to properly read all related data increases because the OLTP database constantly changes. It is noted however, that a correction mechanism described with reference to FIG. 3 addresses this potential source of inaccurate data change information. Second, to ensure that the net change server 18 will keep running, automatic restart of the net change server is enabled by means of a periodically executed job mechanism. Third, the net change server tracks data status as the data changes progress through the net change server 18's processes to ensure that the net change server 18 processes a change exactly once. By tracking progress at each stage through the net change server 18's processes, the server 18 is capable of continuing where processing was previously interrupted. Tracking, in the form of synchronizing data storage and retrieval in a store 22, is also incorporated into the exemplary embodiment of the data change server system.

The business object net change, or more generally a net change, generated by the net change server 18 is stored with other net changes in the store 22. The changes in the store 22 are made available to a variety of applications in a potentially broad variety of ways (via various data synchronization interfaces/mechanisms). The net change database 22 is accessible by applications via a business object interface (BOI) 24 that is, in turn, invoked by client applications. Alternatively, instead of storing the data change objects and waiting for a client application to request them, the net change server 18 publishes the data change objects via a publisher 28 as soon as that communication component is available. In the case of publication via the publisher 28, the data change objects are not combined to form “net change” objects since the delay in publishing the changes is not likely to be sufficiently long to render multiple pending data change objects on a same data object.

Decoupling transaction processing, by the server 18, from the OLTP application 10 and the client application interface (e.g., BOI 24 and publisher 28) minimizes processing/wait time for both interfaces. Currently the BOI 24 implements a pull mechanism for retrieving data. Thus, a period of idle time will typically exist, between the time a change is made by an OLTP user and the time a client requests net changes, in which data (e.g., changes) can be processed by the net change server 18. The data processing does not interfere with the user transaction nor does processing increase response time.

Configuring the net change server 18 is based on business requirements and interface requirements. To optimize performance, a configuration provided by configuration settings 26 are compiled into an executable program or library. Configuration settings 26 are described herein below with reference to a description of various interfaces associated with the net change server 18 embodying the present invention (as depicted in FIG. 4). It is noted that the present invention is embodied, by way of example, within a net change server 18 that includes a functional component for aggregating changes of multiple related data change objects into a single net data change object. However, other embodiments do not include the data change object aggregation functionality. In such embodiments the data change server system renders at least one data change object for each set of changes submitted in a single database transaction (i.e., the changes for distinct database transactions are incorporated into separate data change objects regardless of whether they relate to a same data object).

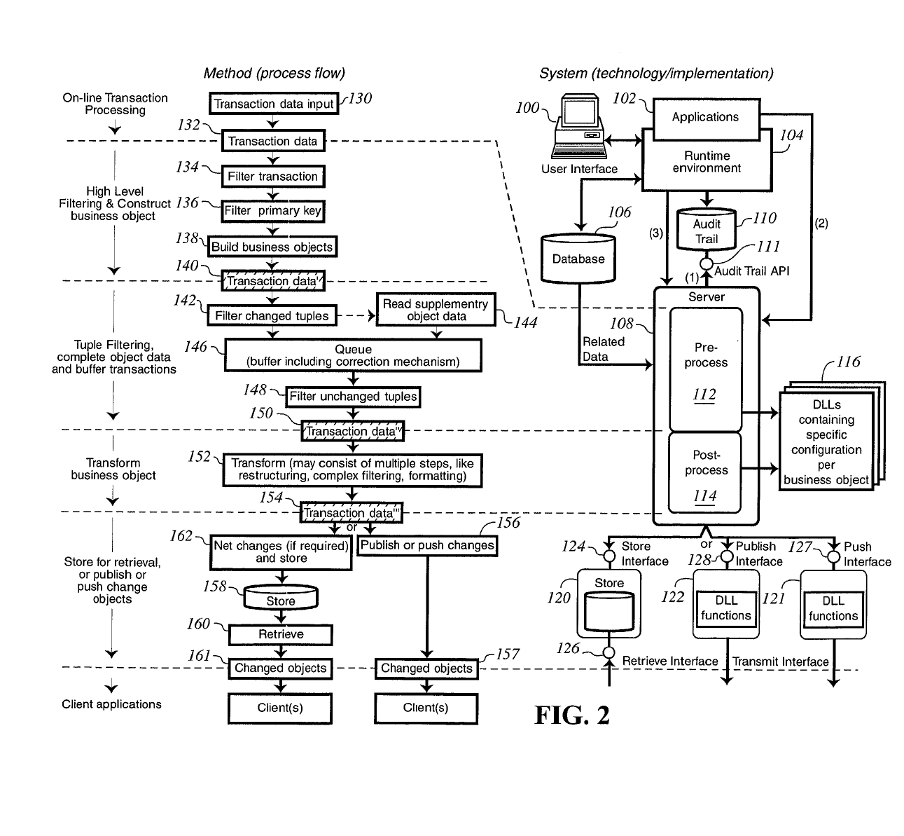

Turning now to FIG. 2, a functional block diagram of a system embodying the present invention is depicted along-side a summary of process flow steps incorporated into an exemplary embodiment of the present invention. FIG. 2 relates some of the functional components discussed above with reference to FIG. 1 to a set of process steps that render data change objects based upon OLTP transactions. Turning first to the system diagram portion of FIG. 2, an exemplary user interface 100, such as for example a network connected personal computer, executes applications 102 in a runtime environment 104. An example of a the applications 102/runtime environment 104 is the known BaanERP suite. A user submits requests/instructions to the run-time environment 104. The runtime environment 104 then submits change instructions corresponding to the requests/instructions to table entries within a database 106. While only a single user interface is shown, those skilled in the art will understand that the database 106 operates as a repository of database change requests submitted by multiple copies of the applications 102 and runtime environment 104. If accepted, the changes are applied to a new or existing entry within the database 106.

A server 108 of the change server system receives raw database transaction information from the applications 102 via multiple potential channels. First, an audit trail 110 is created by the runtime environment 104 in association with the applications 102. More specifically, the server 108 instructs the audit trail API 111 to receive transaction data that meets a particular criteria. If no such data is presently located within the audit trail 110, then the audit trail API will check again after a period of time. The audit trail API 111 checks for new transactions by polling a transaction notification table. When the audit trail API 110 locates and receives a transaction from the audit trail 110, it sends an event trigger to the server 108 indicating a received transaction, and the server 108 retrieves the received transaction data from the audit trail 110. The above described transaction retrieval scheme is exemplary. In an alternative embodiment of the invention, the server 108 pulls transactions from the audit trail 110. Second, the applications 102 directly transfer transaction information to the server 108. A process within applications 102 transmits transactions to the server 108. In an embodiment of the invention, applications 102 wait for a specified event to occur before transmitting the transactions to the server 108. In this case, the server processes the transactions either in the scope of a database transaction from the application or alternatively within the scope of the server 108. Third, a system trigger within the runtime environment 104, operating outside the scope of the applications 102 and server 108, waits for a configured triggering event and then passes relevant transactions generated by the applications 102 to the server 108. Examples of the third channel type are DBMS (database management system) triggers and virtual machines that operate the applications 102.

The server performs the general task of building data change objects specifying changes executed on identified data constructs, such as for example, data objects (such as a store's orders). The identified data objects (and more generally identified data constructs) exist for at least the purpose of providing a context for the data change objects provided by the server 108 to other applications. In addition to transaction data received via the above mentioned database transaction sources, the server 108 accesses the database 106 to obtain supplementary data relating to the received transaction data. The server 108 utilizes the accessed data to complete a data change object.

The server 108 includes a preprocessor 112 and postprocessor 114. Both the preprocessor 112 and postprocessor 114 are completed by specified dynamically linked libraries (DLLs) 116 determined by configuring the server 108. The server 108 itself comprises a template and basic generic functions needed for all server configurations. Specific functions designated during configuration of the server are stored in the library that is an attribute of a server object described herein below with reference to FIG. 6. The specified library contains functionality that is specific for a particular server configuration. A list provided herein below sets forth mandatory and optional functionality designated during configuration and supplied by the library of a configured server.

To define the business data change object:

1 (mandatory) specify tables and columns to be processed, to specify what transactions must be received via the audit trail

To build up the business data change objects:

2a (mandatory if the business object has more than one level) specify how to build up the business object, to determine parent entity (or entities) and primary key (or keys) based on child entity and primary key.

2b (optional) get the mandatory attributes for unchanged parent tuples, by reading them from the database (e.g. to read the order status from the order header in case only order lines were changed in the transaction)

2c (optional) read additional tuples for object (in the case of complete family mode)

To filter the business data change objects:

3a (optional) specify filter at transaction level (filter on user or session)

3b (optional) specify filters on primary key columns

3c (optional) specify filters on non primary key columns

Transformations and other post-process functionality:

4a (optional) specify transformation steps. E.g. first filter at object level, then transform the object (combining or splitting up tuples), then add some additional data from other business objects, then format the tuples. Not only are the contents of the steps configurable, but also the number of steps and their sequence.

4b (mandatory unless 4c is specified) specify the store to be used for the resulting data change objects.

4c (mandatory unless 4b is specified) specify custom end process (to be used instead of standard store), to customize the action to be taken. For example, if a customer uses publish/subscribe middleware, or wants to apply the transaction immediately to another database, or needs to take another specific action.

The above options are specified and then compiled into a dynamically linked library that is accessed by the server 108 during runtime.

Output from the server 108 is provided to either or both a store 120, a push notification mechanism 121, and/or a publish/subscribe notification mechanism 122. The store 120 receives data change objects from the server 108 via a store interface 124. Applications retrieve data change objects (including net change objects) via a retrieve interface 126 that generally operates according to a “pull” mechanism initiated by applications that receive the data change objects or net change objects having aggregated changes. The publish/subscribe notification mechanism 122 includes an interface 128 that is similar to the store interface 124. However, in contrast to the store 120, the publish/subscribe notification mechanism 122 broadcasts changes to the applications that subscribe to particular changes. The push notification mechanism 121 includes an interface 127 that is similar to the interface 128 of the publish/subscribe notification mechanism. However, the push notification mechanism 121 selectively transmits data change objects to particular recipients. The store 120, push notification mechanism 121, and publish/subscribe notification mechanism 122, by way of example, reside on the same physical computer system as the server 108.

Before turning to the process flow depicted in FIG. 2, the operation of the server 108 is summarized in the form of pseudo code. The main process of the net change server operating in near real time mode generally operates as follows:

Main process for running in near real-time mode:

send signal containing start time to store saying server is started

repeat

if get database transaction then

send transaction data to process transaction

else

send signal to process transaction (saying server is alive and showing how far it got)

end if

until process is stopped

Process transaction:

filter changed tuples

add additional object data

buffer the transaction and do corrections if required

for each transaction to be de-queued

filter unchanged tuples

do transformations if required

send transaction (or signal) to store or to custom process

update server status

commit the transaction

end for each

Having provided a pseudo code description of the server process, attention is directed to the steps/stages in FIG. 2 depicting the process flow (and resulting structures), during a transaction input processing step 130 the server 108 receives database changes originating from applications submitted via any of the identified change notification channels (audit trail, applications, trigger mechanisms). Box 132, represents the state of the change data when it is received by the server 108. In the exemplary embodiment of the invention, the received change data is grouped according to a transaction executed on the database, and the received change data is processed by the server 108 on a transaction basis. Each transaction includes one or more changes to the database requested by an application.

Received transactions are initially handled by the preprocessor 112. In an embodiment of the invention, the preprocessor 112 initially applies a series of configurable filters on the received changes. Initially, filters are applied to data included in all transactions. For example, filtering the primary key can be done immediately, because the primary key value will always be available (and it won't change). Early filtering performed by the preprocessor 112 is optional and limited. However, it can provide substantial performance improvement by, in particular, avoiding costly access to the database 106. Preprocessor filtering identifies irrelevant changes that will ultimately be discarded prior to an output stage. In later stages filtering is performed based upon supplemental data and/or transformed change data fields. In summary the change system applies filtering at the following steps: (1) on a transaction, when reading a transaction from the audit trail; (2) on a primary key immediately when reading a database action from the audit trail; and (3) at the end, at the moment of releasing an object (e.g., after resolving potential conflicts).

With reference again to FIG. 2, after receiving a transaction including a change to a database entry, the pre-processor 112 applies the first of several filters, a transaction filter, during step 134. In the exemplary embodiment of the invention, a number of filters are available at the transaction filtering step 134. First, the preprocessor filters transactions based on commit time. For example, the preprocessor 112 will pass transactions that are executed on the database 106 between 6 am and 6 pm, executed on a normal business day, etc. Second, the preprocessor 112 filters transactions on an identified session/program that executed the transaction. For example, the preprocessor 112 only passes transactions that originate from sessions or programs from the Financials software package, or only passes transactions from a specific processing session. Yet another filter applied during step 134 is one that filters transactions based upon an identified user that initiated the transaction. Such a filter, by way of example, facilitates passing transactions performed by a specific user or alternatively excluding transactions initiated by an identified user or class of users.

During step 136 the preprocessor 112 applies a defined filter on a primary key (i.e., one that uniquely identifies the changed entity (e.g., tuple)). Filtering at an early stage can have a substantial impact upon overall system performance if a large portion of the irrelevant changes can be identified and discarded without having to first perform costly database retrievals and information correction. An example in which immediate filtering on primary key values improves performance extremely is the Planned Inventory Transactions database table in the BaanERP program suite. The Planned Inventory Transactions table contains inventory movements for all kinds of orders. On the other hand, the client application (BaanSCS) that receives changes on the BaanERP Planned Inventory Transactions table discriminates between different kinds of orders. In the client application, inventory movements for purchase orders, customer orders, distribution orders, warehouse orders, and substitution orders, are regarded as separate objects. If the preprocessor 112 does not apply primary key filter on order type until the post-process, the preprocessor 112 load is, for example, five times as heavy as necessary to propagate changes to the client application because eighty percent of the changes are ultimately discarded as irrelevant. In that case, preprocessor filtering on the primary key eliminates a majority of the changes—those that are irrelevant to the client application—and reduces the workload on the change system.

Next, during step 138, the preprocessor 112 commences building data change objects (e.g., business data change objects) based upon the information contained in the received transaction. Box 140 represents the data change objects built during step 138 and referenced in FIG. 2 as Transaction data′. Transaction data′ contains one or more data change objects. For example, the preprocessor 112 during step 138 converts four database changes into two data change object—each representing two of the database changes. In an embodiment of the present invention, the data change objects are described through the use of self-identifying data type descriptors. In particular, the data change objects are defined by XML tagged entries defining the various fields of the data change objects.

The following describes the content of the data change tuple and object change that make up exemplary data change objects in accordance with an embodiment of the present invention.

A data change (tuple) contains:

entity identification (e.g. a database table, or a structure in an application program)

primary key value (e.g. a unique index value) to identify the tuple

the action (e.g. insert, update, delete)

the attribute values (in case of an insert: the after image; in case of a delete: the before image; in case of an update: the before and after image for the changed attributes).

An object change is a single-level or multilevel structure containing one or more related tuples from one or more entities, where

each tuple can be a data change or an unchanged tuple

each changed tuple may contain additional unchanged attribute values

each unchanged tuple has a single image (or a before and after image that are equal)

The following is an exemplary set of pseudo code describing the decision process building data change objects based upon a transaction. Of course those skilled in the art will readily appreciate that many alternative decision processes can be formulated to build data change objects.

BEGIN
for each changed tuple in transaction

determine parents for that change
if nr.parents > 0 then

nr.parents.existing = 0
last.parent.existing = 0
| get reference to lowest existing parent
while nr.parents.existing < nr.parents
and tuple(nr.parents.existing+1) already exists

nr.parents.existing = nr.parents.existing + 1
last.parent.existing = found.tuple

end while
| add non-existing parents and their references
for i=nr.parents.existing + 1 to nr.parents

if last.parent.existing > 0 then

create parent-child relation between
existing parent and parent(i)

end if
add parent(i)
last.parent.existing = added tuple

end for
if last.parent.existing > 0 then

| add reference to last.parent.existing
create parent-child relation between existing parent and
tuple to be added

end if
if nr.parents.existing < nr.parents then

| simply add the tuple, because it does not yet
| exist since its parent did not exist.
add tuple

else

if tuple does not yet exist

add tuple

else

net change changed tuple and existing tuple

end if

end if

else

| changed tuple is top-level tuple
if changed tuple does not yet exist

add changed tuple as a new object

else

net change changed tuple and existing tuple

end if

end if

end for each

Though the above pseudo code is self explanatory, the following features are noted. The step “determine parents for that change” determines the number of parents and the identification for each parent. Like a tuple, a parent is identified by its entity (e.g., “order header,” or “operation”) and its primary key value (e.g., an order number). Next, take a “production order” object consisting, for example, of multiple “operations,” and where each operation includes a number of “resources.” If a change on a production order header is received, then it will have no parents, because the production order header, by itself, identifies the object. If a change on an operation is received, one parent is determined (being a production order header). If a change on a resource is received, two parents are determined (the production order header and the operation that comprises the resource).

The data change object building process summarized above in pseudo code ensures that the following actions will occur when a data change object is created by the server 108. First, if a particular identified tuple already exists within the presently processed transaction, the server 108 executes a net change to combine both changes on the same tuple. However, if the tuple does not exist, but its parent tuple does, the change is added as a child to the existing parent. Furthermore, if the tuple and its parent do not exist, but its grandparent does, then the server 108 adds a parent and the corresponding parent tuple as a child and grandchild to the existing grandparent tuple. If the top-level parent does not exist, the server 108 creates a new object containing the tuple.

Having described an exemplary tuple building process carried out by the processor 108 during step 138 in substantial detail, we return to the summary of process flow with continued reference to FIG. 2. After the preprocessor builds the data change objects, additional filters are applied during steps 142 and 148 prior to making the data change object available to a client application via the retrieve interface 126 and/or publication interface 122. During the subsequent filtering, if there is a filter on non-primary key values, each tuple is ideally filtered exactly once, and, more importantly, the preprocessor 112 does not skip a filter for a tuple when, for example, the action type of a child tuple changes from “unchanged” to insert or delete while filtering its parent. In the steps described herein below, the functionality of steps 142 and 148 is the same. However, during step 142 the preprocessor applies filters to changed tuples, and during step 148 the preprocessor applies filters to unchanged tuples. Depending upon an action type specified for the data change object tuple, the filter stages 142 and 148 execute filters upon old values or new values within the data change object.

Furthermore, tuple filtering during steps 142 and 148 in some instances changes the action type for the tuple. The relation between action type and filtering is summarized in Table A.

TABLE A

| Pre | | | |
|---|---|---|---|
| Action | Before image | After image | Post |
| type | in range | in range | Result |
| Insert | — | N | Tuple deleted from tree: out |
| | | | of range |
| Insert | — | Y | Tuple not changed |
| Delete | N | — | Tuple deleted from tree: out |
| | | | of range |
| Delete | Y | — | Tuple not changed |
| Update | N | N | Tuple deleted from tree: out |
| | | | of range |
| Update | N | Y | Action type changed to insert |
| | | | (before image is removed) |
| Update | Y | N | Action type changed to delete |
| | | | (after image is removed) |
| Update | Y | Y | Tuple not changed |

In summary of the above table, in the case of an insert action, the filtering is applied on the new values. If the new values are within range, then the tuple is passed on for further processing. If the new values are out of range, the tuple is removed from the internal data structure and consequently it will not be sent to the post processor for further processing.

In the case of a delete action, the filtering is applied on the old values. If the old values are within range, the tuple is passed on for further processing. If the old values are out of range, then the tuple is removed from the internal data structure and will not be passed on for further processing.

In the case of an update action, the filtering is applied to both the old and the new values. If both the old and new values are within range, then the tuple is passed on for further processing, and the action type remains ‘update’. If none are within range, the tuple is removed from the internal data structure and consequently it will not be sent to any client applications. If the old values are within range and the new ones aren't, the action type will be changed to ‘delete’, and the tuple is passed on for further processing. If the new values are within range and the old ones aren't, the action type will be changed to ‘insert’, and the tuple is passed on for further processing.

Filtering on tuples may have implications for part, or all, of a data change object. For example: if one order line is within range, but another order line is not, then the order line (tuple) that is out of range will be removed from the data change object before the data change object is passed on for further processing. On the other hand, deleting an out of range tuple may create an impact on the object as a whole. For example, when an inserted order header is out of range, it will be removed from the transaction, and its children (order lines) are also removed. In general, with regard to the effect of filtering of a parent tuple upon its children, if a parent tuple is removed when filtering, its child tuples are also removed. If the action type of a tuple is set to ‘insert’ or ‘delete’ while filtering, the action type of all child tuples is also changed to the new action assigned to the parent tuple.

Having described tuple filtering as it generally applies to both step 142 and 148, attention is returned to step 142 of FIG. 2 wherein the preprocessor 112 filters tuples of a data change object built during step 138. Such tuples, created without reference to related data stored in the database 106, are referred to herein as “changed tuples.” Splitting tuple filtering between changed tuples during step 142 and unchanged tuples during step 148, provides an added benefit of discarding irrelevant changes prior to a first request for data from the database 106. For example, when processing sales orders, a header filter is applied on the order header (e.g. order status<3) and the order lines (e.g. item code>“something”). If, in a database transaction only one or more order lines are changed without changing the header, a portion of the tuple filtering can be applied before reading the related header data from the database 106. In this example, the preprocessor 112 applies the order line filter to determine whether those changes meet ranges set for the order lines' item codes. If any of the order lines do not meet a range code, then the transaction is discarded prior to retrieving header data from the database 106 to facilitate applying the header filter to the unchanged header tuple.

If, at step 142, the changed tuples pass the filters, and if additional related information is needed from the database to complete the data change object, then step 144 is performed to retrieve and incorporate unchanged data (e.g., header information) into the previously built data change object. At step 142 the preprocessor 112 reads supplementary data from the database 106 that is required to complete the data change object, but is not included in the data change information received from the audit trail. For example, if particular attributes from the order header must always be supplied to a client application, but only the order line is changed, then the required order header data is read from the database. During step 144, the preprocessor reads attributes that would also be read from the audit trail in the event the attributes were changed (e.g., a header attribute). Other attributes are read during a transformation step 152.

Two types of information are added during step 144: attributes for unchanged tuples (parents that were added while building up the business object), and unchanged tuples (“complete the family”). With regard to adding unchanged tuples, the preprocessor 112 during step 144 reads the family members that have not changed (and consequently are not yet included in the changed object). For example, if a sales order and two of its order lines are available, the preprocessor during step 144 reads the additional order lines. Furthermore, filtering is not performed on the unchanged during step 144. Instead the preprocessor 112 initially adds all requested related tuples. Filtering is performed after step 146 when the data is verified as correct. However, during step 144 the preprocessor 112 filters the primary key while reading from the database 106 to eliminate any irrelevant supplementary data retrieved from the database.

As mentioned herein above, the supplementary data is retrieved from the database 106. The data stored within the database 106 generally is more up to date than the audit trail data. To prevent inconsistencies arising from audit trail changes and unchanged related data stored in the database, the transaction data′ is queued during step 146 and not de-queued until the preprocessor 112 has ensured that any subsequent database transactions did not create an inconsistency between the original transaction data received during step 130 and the supplementary data retrieved from the database 106 during step 144. Therefore a queued data change object associated with a particular transaction is de-queued only if:

(1) all data change objects for previous transactions are de-queued (because transactions are de-queued in sequence in which they were queued) AND

(2) the queue time of the transaction, from which the data change objects arise, is earlier than the commit time of the current transaction—presently being processed by the preprocessor 112 OR

the data change objects associated with the transaction are all empty OR for all data change objects associated with the transaction: no data was added while completing the family or calling a function for getting tuple attributes.

In further explanation of the term “current transaction” used to describe the conditions for de-queuing a transaction, as transactions are buffered, the preprocessor 112 continues processing subsequent transactions. Consider a sequence of events where transaction 1001 is committed at t1 and supplementary data is added from the database by the preprocessor 112 at t3. The transaction 1001 is queued, and the next transaction (1002) is processed, and transaction 1002 was committed at t2 (prior to t3). If transaction 1002 contains changes on the same object as transaction 1001, while the preprocessor 112 is processing 1002 (the ‘current transaction’) it may have to correct the object in transaction 1001 as a result of changes entered to the data object when processing transaction 1002.

As mentioned previously above, the filtering unchanged tuples step 148 is the same as step 142—except that filters are applied to unchanged tuples added during step 144. After applying filters to the data change object during step 148, the data change objects are in a state (represented in Box 150 as Transaction data″) such that the consistency of the data within the data change objects is ensured. Transaction data″ is similar in form to Transaction data′. However, unchanged data may have been added and (parts of) objects may have been filtered out.

Continuing with the discussion of FIG. 2, the postprocessor 114 begins processing the de-queued data change objects to render the data change objects in a form for the client applications—which may differ substantially from the form of the de-queued data change object rendered at Box 150. Post-processing is a highly configurable stage wherein virtually any operation, including further filtering, can occur to render the data change objects in a form expected by the client applications. Note that the user might define the sequence of steps such as: first apply a filter on the header, then perform a transformation of child entities, then format the header, then add more data to specified child entities. The following is a list of potential operations executed during the post processing stage:

Filtering at a tuple level. This functionality is the same as filtering in the pre-process stage.

Filtering at an object level. Some filters are not applied to a single tuple and instead are applied to a set of tuples or to the object as a whole. For example, a filter can specify only including production orders that have at least one operation. Another filter may specify including only sales orders where the total amount for all order lines is greater than some value.

Transforming or formatting at a tuple level. For example, a postprocessor combines two attributes of a tuple, or converts a country code, or formats a date or time, or converts a UTC date/time to a local date and time.

Transforming at object level. For example, a postprocessor combines data from multiple tuples.

Adding attributes to a tuple. Such a procedure is comparable to adding a tuple, but instead adds the additional attributes to the existing tuple.

Adding a tuple. This procedure comprises adding a tuple that is not part of the business object, but is included for reference to the benefit of the client application. For example, a postprocessor procedure adds item data to a sales order (line) or business partner data to a sales order (header).

Notwithstanding the wide variety of potential processes available for post processing, in an embodiment of the invention at step 152 the postprocessor 114 performs any configured transformations on the de-queued data change objects. For example, the postprocessor 114 transforms data values by means of a conversion table or instance mapping. The postprocessor 114 also formats the output by, for example, applying a specific date or time format to a data field. Other exemplary functions carried out by the postprocessor during the transforming (e.g., reformatting, remodeling, etc.) step 152 include:

Restructuring the data change object by, for example, combining tuples into a single tuple, or splitting a single tuple into multiple tuples.

Performing data transformations such as adding calculations, or applying data conversions.

Performing complex filtering at an object level instead of tuple level.

Formatting data such as the previously mentioned formatting a date or time.

Adding data outside the scope of the original scope of the data change object. For example, for the sales orders case, in addition to combining sales orders and sales order lines, the postprocessor combines other related data, such as attributes of the item in an order line or attributes of the business partner that placed the order.

While these operations are combined into a single step 152, those skilled in the art will understand that such procedures can comprise multiple distinct steps. The transformed output of the postprocessor 114, represented as Transaction data′″ in Box 154 is then rendered available by the postprocessor 114 for transmission to a client application. Depending upon the scope of the post processing operations performed upon the Transaction data′, Transaction′″ may be similar to Transaction data′, or differ significantly, due to the wide variety of potential transformation actions that are potentially performed during the transforming step 152. During the step 152 the postprocessor potentially adds data, removes data, reformats data, or remodels the arrangement of tagged fields within the XML object.

Rendering the Transaction data′″ available consists of, for example, placing the data change objects represented by Box 154 within the store 120 or alternatively placing the data change objects into a data space (e.g., a queue) to be transmitted by the publish interface. If a data change object is to be published/pushed to a client application, then control passes to step 156 and the data change object 157 is transmitted to the appropriate client(s). If however the data change object is to be retrieved by the client(s), then the data change object is forwarded to the store 120 during step 158. Thereafter, during step 160 a client application submits a request to the server retrieve interface 126 to retrieve a stored data change object 161 for the client application.

It is noted that in an embodiment of the invention, during step 162 the data change object is applied to other corresponding data change objects to render “a net change object”—a special case of data change object that represents multiple, aggregated changes represented in multiple combined data change objects. to a data change object propagation facility. Net change objects are addressed further herein below.

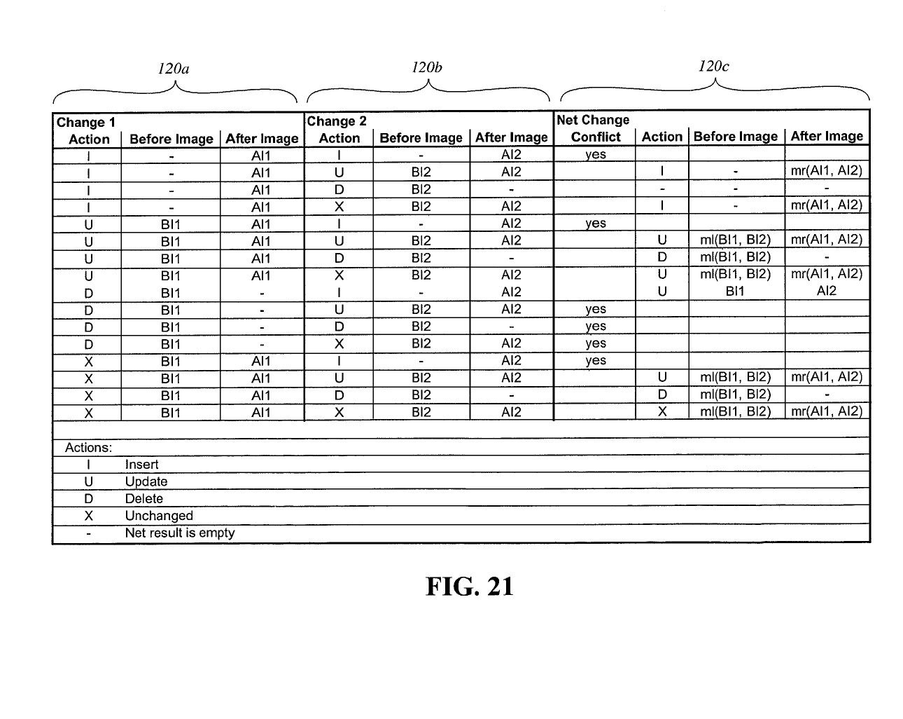

After creating a set of data change objects, in an embodiment of the present invention configured to combine data change objects to render net change objects, the store 120 component merges similar, non-retrieved data change objects into “net change objects”. Table B providing a general convention for merging attributes of a tuple, in conjunction with a spread sheet set forth in FIG. 21, illustratively depict an example of merging two related data change objects to render a new net change object.

TABLE B

| Image I1 | Image I2 | ml (I1, I2) | mr (I1, I2) |
|---|---|---|---|
| <empty> | <empty> | <empty> | <empty> |
| a1 | <empty> | a1 | <empty> |
| <empty> | a2 | <empty> | a2 |
| a1 | a2 | a1 | a2 |
| a1 | b2 | a1, b2 | a1, b2 |
| a1, b1 | b2, c2 | a1, b1, c2 | a1, b2, c2 |

In TABLE B, a, b and c represent attributes of the tuple. In FIG. 21, the first group of columns (change 1) 120a represents a database change that occurs first in time. The second group of columns (change 2) 120b represents a database change that occurs next in time. The third group of columns (net change) 120c represents the resulting structure (including before and after images) when the second change is applied to the first change to render a net change for 16 distinct scenarios. The ml function in TABLE B and FIG. 21 refers to a ‘merge left’ action, i.e. a merge action where the attribute values in the before image I1 get precedence over the attribute values in the after image I2. In the mr (‘merge right’) function, the after image values get precedence. Also, “BIn” stands for a before image of change n, and “AIn” stands for after image of change n. With regard to the blank entries in the case of a net change conflict, such conflicts are handled in two different manners based upon whether the server is operating in a fault tolerant mode. In the fault tolerant mode, conflicting actions are merged. In non-fault tolerant mode, the conflicting changes are not merged.

As those skilled in the art will readily appreciate, there are many possible ways to perform a net change on an object. One or more can be implemented in a single net change server when combining data change objects relating to a same data object. The following describe some of the alternatives.

Method A: per entity

for each entity X in meta data

for each tuple in second change having entity X

find tuple in first change
if tuple does not exist in first change then

add tuple to first change

else

combine tuple and existing tuple

end if

end for each

end for each

Method B: per tuple

for each tuple in second change

find tuple in first change
if tuple does not exist in first change then

add tuple to first change

else

combine tuple and existing tuple

end if

end for each

Method C: top-down

Is comparable to method B, but the tuples are handled starting at the top of the second changed object.

Method D: bottom-up

Is comparable to method B, but the tuples are handled starting at the bottom of the second changed object.

Method D does not, generally speaking, provide any advantages over method B, but method C is generally preferred in a number of cases because, if it is known that a parent tuple does not exist in the first change, one also knows its children do not yet exist. Therefore the processor performing the netting of the changes can add them together with their parent.

Having described an exemplary process for creating net change objects, a sequence of transactions are described, and a set of XML objects are defined, in accordance with an embodiment of the present invention. This section contains an example on sales orders and order lines. The exemplary sequence of transactions demonstrates combining/aggregating multiple data change objects to render a net change object. The transactions described are cumulative. Therefore each data change object is combined with the previous (net) data change object. The actual XML format used in an implementation of the present invention may be different.

In the exemplary transactions that follow, the XML tags are to be interpreted according to the following set of definitions. Those skilled in the art will readily appreciate that other tags/definitions can be used in alternative embodiments of the invention. “actionType” is the type of action performed on the tuple (insert, update or delete). Unchanged means no update was done on this tuple. Note that the action of the object as a whole can be derived from the action on the top-level tuple. “oldValues” identifies a portion of a data change object holding old values (before image) of the tuple. “newValues” identifies a portion of the data change object holding new values (after image) of the tuple. In this particular example, the parent-child relations between tuples are carried out by means of references (href) to the child tuple (id).

Transaction 1: Insert an order ORD001 having one order line.

The net change server will create the following structure:

<object objectType=salesOrder actionType=insert>

<tuple entity=salesOrderHeader actionType=insert>

<oldValues/>
<newValues>

<orderNumber> ORD001 </orderNumber>
...

</newValues>
<tuple href=#1 />

</tuple>
<tuple id=1 entity=salesOrderLine actionType=insert>

<oldValues/>
<newValues>

<orderNumber> ORD001 </orderNumber>
<orderLineNumber> 1 </orderLineNumber>
...

</newValues>

</tuple>

</object>

The Store object will receive this structure, and since this order is not yet existing in the store, the structure will simply be stored.

Transaction 2: Delete the order line and order header of ORD001.

The net change server will create the following structure:

<object objectType=salesOrder actionType=delete>

<tuple entity=salesOrderHeader actionType=delete>

<oldValues>

<orderNumber> ORD001 </orderNumber>
...

</oldValues>
<newValues/>
<tuple href=#1 />

</tuple>
<tuple id=1 entity=salesOrderLine actionType=delete>

<oldValues>

<orderNumber> ORD001 </orderNumber>
<orderLineNumber> 1 </orderLineNumber>
...

</oldValues>
<newValues/>

</tuple>

</object>

The Store object will receive this structure, and observe that ORD001 already exists in the store. The net result of the existing structure and the new one will be determined. The result will be an empty structure. ORD001 will be completely deleted from the store.

Transaction 3: Insert an order ORD002 having one order line.

The net change server will create the following structure:

<object objectType=salesOrder actionType=insert>

<tuple entity=salesOrderHeader actionType=insert>

<oldValues/>
<newValues>

<orderNumber> ORD002 </orderNumber>
...

</newValues>
<tuple href=#1 />

</tuple>
<tuple id=1 entity=salesOrderLine actionType=insert>

<oldValues/>
<newValues>

<orderNumber> ORD002 </orderNumber>
<orderLineNumber> 1 </orderLineNumber>
...

</newValues>

</tuple>

</object>

The Store object will receive this structure, and since this order is not yet existing in the store, the structure will simply be stored. So now one order is stored: ORD002.

Transaction 4: Add an order line to ORD002.

The net change server will create the following structure:

<object objectType=salesOrder actionType=update>

<tuple entity=salesOrderHeader actionType=unchanged>

<oldValues>

<orderNumber> ORD002 </orderNumber>

</oldValues>
<newValues>

<orderNumber> ORD002 </orderNumber>

</newValues>
<tuple href=#1 />

</tuple>
<tuple id=1 entity=salesOrderLine actionType=insert>

<oldValues/>
<newValues>

<orderNumber> ORD002 </orderNumber>
<orderLineNumber> 2 </orderLineNumber>
...

</newValues>

</tuple>

</object>

The order header tuple is created by getting the related data. In this case the process is optimized, because the order number is already known from the order line, and no other information is needed from the order header. Therefore, the sales order header tuple can be created without reading the OLTP database. If additional data is required, e.g. other attributes of the order, or attributes from the business partner that placed the order, then the OLTP database must be read to get this additional data.

The Store object will receive this structure, and reads the store. It will find the existing ORD002. The net result of the existing ORD002 and the new ORD002 will be determined, resulting in:

<object objectType=salesOrder actionType=insert>

<tuple entity=salesOrderHeader actionType=insert>

<oldValues/>
<newValues>

<orderNumber> ORD002 </orderNumber>
...

</newValues>
<tuple href=#1 />
<tuple href=#2 />

</tuple>
<tuple id=1 entity=salesOrderLine actionType=insert>

<oldValues/>
<newValues>

<orderNumber> ORD002 </orderNumber>
<orderLineNumber> 1 </orderLineNumber>
...

</newValues>

</tuple>
<tuple id=2 entity=salesOrderLine actionType=insert>

<oldValues/>
<newValues>

<orderNumber> ORD002 </orderNumber>
<orderLineNumber> 2 </orderLineNumber>

</newValues>

</tuple>

</object>

The above specified XML tagged structure will be stored instead of the previous ORD002. So now one order is stored: ORD002.

Transaction 5: This transaction contains four actions: (1) add a new order ORD003, (2) delete order line 1 of ORD002, (3) add an order line to ORD003, (4) update this order line of ORD003.

The net change server creates two structures, one for each order involved.

The first structure will contain the net result of action (1), (3) and (4):

<object objectType=salesOrder actionType=insert>

<tuple entity=salesOrderHeader actionType=insert>

<oldValues/>
<newValues>

<orderNumber> ORD003 </orderNumber>

</newValues>
<tuple href=#1 />

</tuple>
<tuple id=1 entity=salesOrderLine actionType=insert>

<oldValues/>
<newValues>

<orderNumber> ORD003 </orderNumber>
<orderLineNumber> 1 </orderLineNumber>
...

</newValues>

</tuple>

</object>

The insert and update of the order line are merged into one new order line, having no old values.

The second XML tagged structure contains the result of action (2):

<object objectType=salesOrder actionType=update>

<tuple entity=salesOrderHeader actionType=update>

<oldValues>

<orderNumber> ORD002 /orderNumber>

</oldValues>
<newValues>

<orderNumber> ORD002 /orderNumber>

</newValues>
<tuple href=#1 />

</tuple>
<tuple id=1 entity=salesOrderLine actionType=delete>

<oldValues>

<orderNumber> ORD002 </orderNumber>
<orderLineNumber> 1 </orderLineNumber>
...

</oldValues>
<newValues/>

</tuple>

</object>

The Store object/process receives two structures. Since ORD003 does not yet exist in the store, the structure on ORD003 will simply be stored.

The new structure on ORD002 will be combined with the existing one, resulting in:

<object objectType=salesOrder actionType=insert>

<tuple entity=salesOrderHeader actionType=insert>

<oldValues/>
<newValues>

<orderNumber> ORD002 </orderNumber>
...

</newValues>
<tuple href=#2 />

</tuple>
<tuple id=2 entity=salesOrderLine actionType=insert>

<oldValues/>
<newValues>

<orderNumber> ORD002 </orderNumber>
<orderLineNumber> 2 </orderLineNumber>
...

</newValues>

</tuple>

</object>

This structure will be stored instead of the previous ORD002. Note that order line 1 no long exists. If an order line is inserted and in the same period deleted again, the net result will be empty.

Yet another aspect of data change processing is to ensure that changes to supplementary data in the database 106, resulting from transactions committed after an earlier transaction causing a change to a data entry, are not inadvertently swept into processing of the earlier transaction. Such potential errors arise from latencies in processing the data changes previously committed to the database. A correction mechanism, in an exemplary embodiment of the present invention, resynchronizes a change to a data entry and subsequently modified related supplementary data retrieved from the database 106 to complete a data change object incorporating the change to the data entry.

Turning now to FIG. 3, a timing diagram depicts how such inaccuracies arise, and the correction mechanism described herein below (depicted in FIG. 2 by queuing step 146) provides a solution to the problem. When combining data from the audit trail 110 and the database 106, the server 108 potentially combines images from different moments in time. Thus, inconsistencies may arise in the data change object image created from these two data sources. For example, if the net change server picks up a changed order line from the audit trail and reads the order header from the database, the status of the order header may change between the moment the order line was changed and the moment the server 108 reads the order header. The net change server incorporates a correction process wherein the header and order line are “synchronized.” Preferably, synchronization is carried out by reversing (or “rolling back”) any changes that occur to the supplementary (header) information as a result of a transaction committed to the database 106 after a transaction committing the change to the data entry (order line).

With reference to FIG. 3, transactions are committed to the OLTP database at t₁, t₂, etc. At tₙ′ the transaction from tₙ is picked up and processed by the net change server. The process operates as follows. When the transaction committed at time t₁ is picked up and combined with supplementary data read from the database (indicated by the dashed arrow), the server 108 in effect combines transaction data committed at time t₁ and supplementary data committed at time t₃. In the period between t₁′ and t₃′ the server 108 processes transactions committed between t₁ and t₃ that may have caused a difference between those two sets of data (for example, a transaction at t₂ changing a value relating to the change object associated with the t₁ transaction). In that period the server 108 reverses a change to supplementary data committed at time t₂ to render the data change object as constructed at t₁′. At t₃′ the server 108 has ensured the accuracy of the data change object image because any intervening changes to the supplementary data have been accounted for (by reversing the changes). Therefore, at that moment the server 108 releases the data change object. This process introduces a minor additional latency, but it ensures the published data change objects are internally consistent (e.g., have synchronized header and order line data).

In the above-described embodiment, subsequent changes (i.e., those committed after t₁) to supplementary data in the database 106 are “rolled back” to render a synchronized data entry and supplementary data at time t₁. However, in an alternative embodiment of the invention, the data entry and supplementary data are synchronized by moving the synchronization horizon of the data entry and the supplementary data forward. The horizon is moved, for example to t_{3,} or alternatively the horizon is moved to some intermediate time (e.g., t₂) by incorporating changes incorporated into the data change object up to the latest time (or sequence number) of a change to the supplementary data.

Turning now to FIG. 4, the structure of the net change server of the present invention is illustratively depicted with reference to the flow of information via a set of configuration and process interfaces. With reference to FIG. 4, a rectangle represents a functional component of the system. A circle represents a component interface to connected functional component. An arrow represents a call to a component interface. The dotted box around multiple components represents the net change server.

A setup component 200 defines a mapping from database tables of a database to a business object. For example, the mapping defines the tables and columns involved, changes that trigger processing by the net change server 18, and the output of the net change server to applications (e.g. attributes exposed to requesting applications). The setup component 200 also generates a specific instance of a server component 202 (i.e. the generation of code and the compilation to create the runtime environment). The setup component 200 also participates in generating a specific BOI. Thus, the set up component 200 encapsulates both a setup repository and a code generator. Interface I-Setup 204 facilitates configuring settings defining a mapping from table definitions to a business object and compiling the settings of the generated components. A setup user interface 205 utilizes the I-Setup interface 204 to configure a view.

The server component 202 contains executable process code for collecting and processing changes to the database initiated by external user applications. It is noted that the net change server, in an embodiment of the present invention, operates independently from the database that carries out changes to the database according to registered database transactions. The set of operations carried out by the server component 202 includes transaction logging that may be required (e.g. transactions processed, exceptions). An I-Process interface 206 is available for process management ( e.g. to start or stop the server and to get the status of the process. The I-process interface 206 receives requests from a server user interface component 208 (to start/stop and to observe the status of the server) and a Netlist component 210. The I-process interface 206 is described further herein below with reference to FIG. 3. The Netlist component 210 is primarily a client of the net change server that retrieves data change objects from a store component 212. The Netlist component 210 does not normally access the I-process interface 206. However, the NetList component 210 enables a user to start the server 202, via the I-Process interface 206, in instances where a retrieval of data indicates that a store 212 contains a backlog because the server 202 is not running. Such start capabilities are visually depicted in the dotted line connecting the Netlist component 210 to the I-process interface 206.

The store component 212 contains the change data, i.e. the changes and/or net changes collected/processed by the server component 202. The store component 212 also keeps track of its status with regard to stored data and retrieved data. Three interface components facilitate storing, retrieving and purging net changes rendered by the server component 202. Interface I-store 214 facilitates storing changes or net changes from the server component 202. Interface I-Retrieve 216 allows the Net list component 210 as well as other (typically external) applications 217 to retrieve the changes and net changes maintained within the store component 212. Examples of instances were alternative clients are used include: migration from one release to another, collecting data for an OLAP database or data warehouse, or creating an archive for an audit trail.

The NetList component 210 is interfaced via a business object interface (BOI) 218 to external clients 220. The BOI 218 is, in this example, the business object interface offered to the outside world. The BOI 218 is invoked by external clients 220 to retrieve data, execute update actions and/or execute business object-specific logic. The generic NetList component 210 uses the I-Retrieve 216 interface to get the net changes from the store. Multiple clients 220 use the same business object.

Finally interface I-Purge 222 facilitates purging data that is no longer needed (e.g., processed or obsolete). The I-Purge 222 interface is accessed, for example, by a store user interface 224. The I-store interface 214, I-retrieve interface 216 and the I-purge interface 222 are described further herein below.

In an embodiment of the invention, the server component 202 and store component 212 have a one-to-one relationship. Such an arrangement simplifies maintaining synchronous information since there is only a single source for updates to the store. In alternative embodiments, multiple servers supply changes to stores or a single server supplies changes to multiple stores. Yet another reason to separate the server and store components is to facilitate easy replacement of either of the two components without changing the other. For example, the store component having only a capability of supporting pull updates by clients can be replaced by one that also publishes changes without prior solicitation (or any other customized store component). This replacement has no effect upon the server component.

The store object, corresponding to the store component 212 in FIG. 2, can be generically implemented and can therefore be independent of the content and structure of a stored business object. However, when storing net changes, the store object must know an identification of a business object to which the net change applies and the business object's subordinates. For example when storing sales orders and their order lines, the store object must know what attributes identify a sales order and what attributes identify an order line. Otherwise it cannot decide whether two changes on sales orders or order lines refer to a same sales order or order line and consequently whether they must be combined into a single net change.

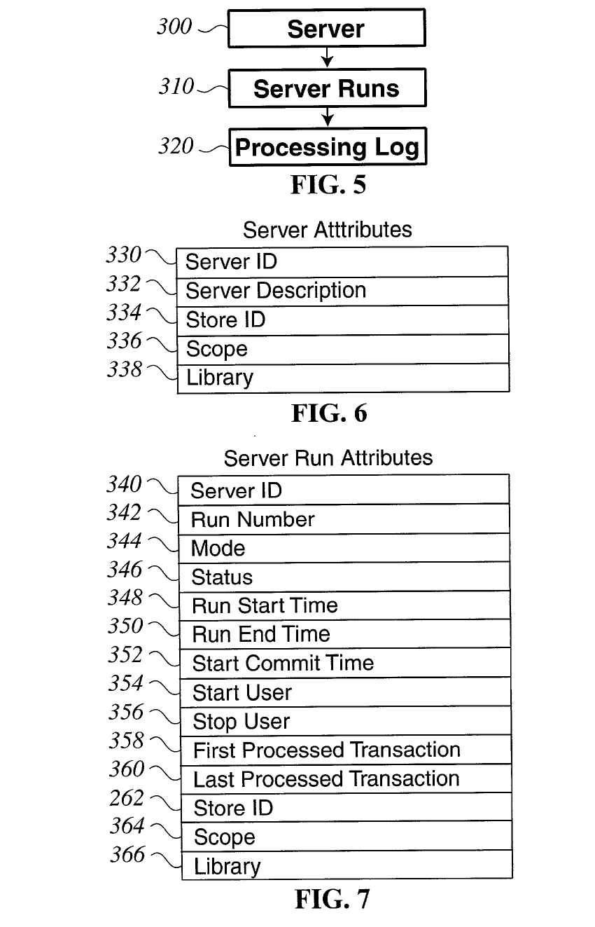

Having described the structural/functional relationships and operation of primary components of a net change server system for a database embodying the present invention, attention is now directed to FIG. 5 that depicts a hierarchical model for the server component 202. While shown as a set of single entities, each arrow denotes a one to many relationship between a parent and child structure. Thus, each server entity 300 references one or more server run entities 310. Each server run entity 310 references one or more processing log entities 320. The primary data entity in the server data model is the server entity 300 that corresponds to each instance of a net change server 18. The server entity 300 runs one or more times, and each run results in creating a distinct one of the server run entities 310. In the preferred arrangement, wherein only one server accesses a corresponding store, ones of the server runs are preferably created sequentially. A same server entity 300 does not process multiple streams of transactions on a database in parallel. An instance of the server run entities 310 in turn creates one or more instances of the processing log 320 such as, by way of example, an exception log.

Turning to FIG. 6, a set of attribute fields that are provided for each instance of the server entity 300 of FIG. 5. An instance of the server entity 300 corresponds to a net change server 18. As mentioned above, the net change server 18 comprises program instructions that read relevant changes submitted by applications to a database, process the changes, and send net changes in a proper format to a store. As shown, by way of example, in FIG. 6 the set of attributes defining a particular instance of the server entity 300 includes a server ID 330. The server ID 330 stores a value uniquely identifying an instance of a server. Next, a server description 332 stores a text string. A logical name or description for the server. A store ID 334 stores a value identifying a store entity to which the server 300 should transfer resulting net changes. The stored value is, for example, a handle for a registered entity or any of a wide variety of means for referencing, either directly or indirectly, a storage location for a set of net changes associated with a particular store entity. A scope 336 identifies the scope of the data passed by the server entity 300 to the store. A “normal” designated scope instructs the server entity 300 to process and send only the changed data in a changed business object to the identified store. A “complete family” scope instructs the server entity to process changes and to store both the changes and unchanged subordinate data lines (e.g., order lines) in a changed business object. The subordinate data lines are included along with a specified “action type”—describing the nature of a change—as “unchanged”. A library ID 338 specifies a library (e.g., a dynamically linked library) containing software server functionality that is specific to the server entity corresponding to the particular combination of attributes set forth in FIG. 6. Such functionality includes: functions for selecting data from the tables and columns to be included in creating net changes, reading related supplementary data, and performing any designated filtering, formatting or transforming data changes. The operation of these aforementioned functions was discussed further herein above with reference to FIGS. 1 and 2.

Turning to FIG. 7, a set of attribute fields are provided for each instance of the server run entity 310 of FIG. 5. As mentioned herein above, each instance of a server run entity 310 corresponds to a net change server run that is presently executing or has already executed. A server run is executed either as a batch run (waiting to process a set of received changes) or in near real-time (as changes are received). In the case of a batch run, the net change server run has a designated start and end. In the near real-time case, the run has a predefined start, but the end of the run is based upon either user intervention once the run begins or an interruption arising from a processing fault.

As depicted in FIG. 7, the set of server run attributes include a server ID 340 that stores a server ID value referencing a server entity for which the run was executed. A run number 342 stores a value, for example a sequence number, assigned to distinguish a net change server execution run from other execution runs performed by the server identified in the server ID 340. Sequencing the values assigned/stored in the run number 342 facilitates ordering the runs in time. A particular server run in an embodiment of the present invention is identified by the combination of values stored within the server ID 340 and run number 342. A mode 344 stores a value designating to mode of operation of the server in view of multiple ways to process changes to render a net change. In the illustrative embodiment the mode value indicates whether the server run is executed in batch or near-real time. A status attribute 346 stores a value indicating the present state of execution of a run. Values assigned to the status attribute 346 indicate, for example, a running, stopped, or interrupted state of the server run.

A set of time values are stored within set of attributes for a server run entity 310. A run start time 348 stores a value identifying a time at which the server run commenced. A run stop time 350 stores a time at which the server run entered a stopped state or was discovered by a user to be in an interrupted state. A start commit time 352 provides a start of a commit time interval specified for the server process. During the commit time interval all transactions processed will have a commit time greater than or equal to this start commit time.

Values are also maintained to indicate an entity that specified a start or stop time for a particular run. A start user 354 identifies a “user” (representing a person or alternatively a registered process) that specified the start of the process. A stop user 356 identifies a user that specified the stop time. If the mode value indicates a batch process, then the stop user is the same as the start user. If the mode equals near real time and the status is “stopped” then the value in the stop user 356 attribute field for an instance of a server run identifies a user who stopped the process. If the mode equals near real-time and the status equals interrupted, then the stop user 356 is the user who discovered the process is interrupted.

Additional attributes help identify the range of transactions (assumed for this example to be identified in a manner identifying their sequential ordering). A first transaction processed 358 identifies a first transaction the net change server (identified by server ID 340) completely processed during the server run. A last transaction processed 360 identifies a last transaction completely processed during the server run. The net change server utilizes a value stored within the last transaction processed 360 to continue an interrupted run and to determine the start of the next run. (Note that in the present embodiment of the invention, the commit time is not sufficiently accurate to achieve this purpose, but may be used in place of the transaction identification in alternative embodiments of the invention.)

Certain other current information in a set of server attributes (see, FIG. 4) are replicated within a server run instance's attributes. A store ID 362, corresponding to the store ID 334 is replicated because a value in the store ID 334 can change between differing runs by a same server entity. A scope 364 value and a library 366 are logged for a server run for this same reason.

The following constraints are generally applied to server runs. A server ID must be specified for each server run. All prior runs are deleted before deleting a particular run (in case there is a need to reconstruct actions represented in a series of different server runs). A server run cannot be deleted while its status 346 indicates that it is still running. Finally, only the most recent run for a server can have a “running” status.

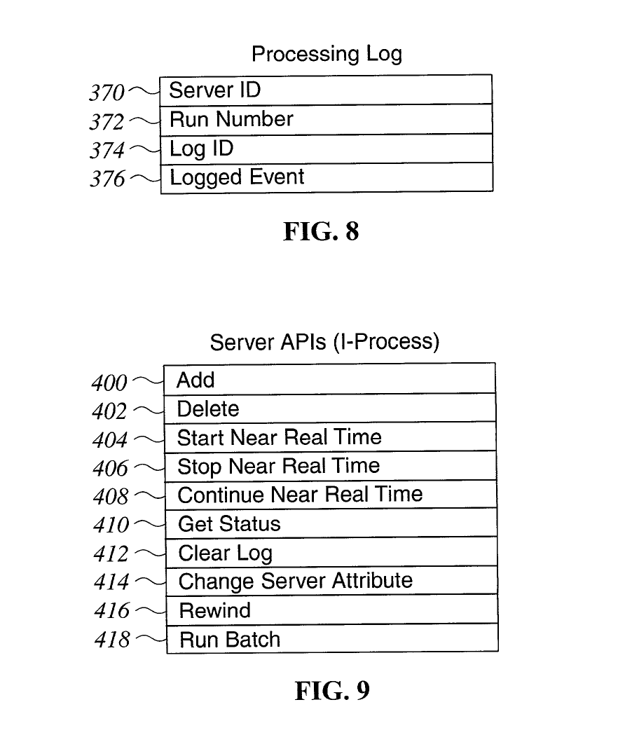

One or more entities are provided to handle exceptions. Rather than storing exception descriptions in a database table, the information pertaining to an exception is preferably, but not necessarily, stored in the form of a log file. Turning to FIG. 8, the processing log entity 320 is uniquely identified by a combination of identification values stored within a server ID 370, a run number 372 that uniquely identify the server run that resulted in the log entry. A log ID 374 distinguishes the log from other log entries generated by a particular server run. An event, or alternatively set of events, are stored within a logged event 376.

Having described the functional relationships between various components and their associated interfaces, attention is now directed to a description of the functionality supported by the component interfaces identified in FIG. 4. The interface descriptions are exemplary, and those skilled in the art will readily appreciate that modifications to the interfaces are contemplated in alternative embodiments of the invention. Turning to FIG. 9, a set of application program interfaces are identified that comprise the I-process interface 206 to the server component 202.

An add function 400 facilitates adding a new net change server to handle changes submitted to the database. The add function is called with a server identification to be used to distinguish the new server, a description (text) generally describing the operation of the new server, a store identification corresponding to the store that receives the net change output of the new server, and a library identification corresponding to a dynamically linked library that contains a set of net change server-specific functions previously described herein above with reference to FIG. 2. The add function 400 does not return an output value. However, the following exceptions are rendered: a new server will not be created and an error will be returned if the named server already exists or a server already exists for the specified store (in an embodiment that allows only one server per store). An error is also rendered if the named library does not exist.

A delete function 402 deletes a net change server component. The delete function 232 also deletes any server runs or processing logs created under the deleted net change server. A server ID is input to the delete function 402 and no output value is rendered. Exceptions returned include, by way of example: an incorrect server ID was specified or the specified server is currently running (only an idled or stopped net change server can be deleted.

It is noted that individual attributes of a server can be changed. The server description can always be changed. The Store ID, Scope and Library can be changed, but the changes will only take effect after the server is (stopped and) started again. A warning is given when changing the Store ID, Scope or Library when the server is running or has already been running. Especially changing the Store ID when the server is running or has already been running introduces a risk, because multiple server runs will write to different stores. This means each of the stores will only contain a subset of the data, while no store will contain the complete data set.

A start near real time function 404 function starts processing changes on the tables specified for an identified net change server, from the specified start time onwards. A background process will be created that will receive any changes and process them on a near real time basis. Input accompanying the call to the start near real time function 404 include: a server identification of the net change server for which processing is to occur on a near real time basis, and a start time. The start time specifies the date and time that is used as the start date and time when processing the data. For example specifying yesterday 8:00:00, causes all transactions committed to the database after this moment (8 a.m. on the previous day) to be processed. This function has no output, but provides exception status for at least the following circumstances: an incorrect Server ID is supplied, the identified server is already running, the start time is later than the current time, and the system is unable to start the server.

A stop near real time function 406 stops processing previously started for an identified net change server by a start near real time function 404. The input consists of an identification of the net change server to be stopped. In an alternative embodiment of the invention a stop time is also specified. This function has no output, but issues an exception when an incorrect server ID is supplied, the server is not running.

A server continue real time function 408 restarts a stopped net change server. The operation of a specified server (ID) is resumed at position in change tables where the net change server previously stopped processing changes. This function has no output, but renders an exception in instances where: an incorrect server ID is specified, the identified server is already running, the identified server has not previously run and is therefore not “stopped,” or the server cannot be restarted.

A get status function 410 returns the present status of an identified server (by server ID). The output of this function returns the present operation status of the server including, by way of example: idle, running (if the server is running in near real time), or interrupted (indicating that the server, running in near real time, is presently in an interrupted state). Additionally the get status function 410 clarifies the status by providing the current or previous run number and the start and end of that run, if applicable. Returned exceptions include: an incorrect server ID was specified in the function call.

A clear log function 412 clears all or part of a log for an identified net change server (by server ID). In an embodiment of the invention, only a single log is provided for a server regardless of the number of runs that are made by the server. In such instance, it is not necessary to identify a log by run number. However, in addition to the server ID the input includes a run number identifying the run number up to which the log is to be cleared. The highest run number for a server is not removed if the flag “Also Clear Last Run” is not set. Furthermore the highest run number for a server is not removed if it has status running, without regard to the setting of the Also Clear Last Run flag. This is because, in the present arrangement, if the last run is cleared, then the server cannot be continued. Instead it is restarted at a specified start time. This may result in duplicates being sent to the store or missing data. The clear log function 412 has no output, but the function will generate an exception if an incorrect server ID is specified.

In addition, a rewind function 416 pauses the net change server (if running), rewinds to a specified time, and then continues from the rewind point (if running). Inputs to the function include net change server ID and a start time that specifies a commit time and date to which the processing should be rewound. An exception is generated in the event that an incorrect server ID is specified. The function has no output.

A run batch function 418 instructs a specified net change server (by server ID) to process all changes on the transaction tables from a start time to a specified end time, or alternatively the current time. A start time input specifies the date and time that is used as the start date and time when processing the data. For example specifying yesterday 8:00:00 causes processing of all transactions committed to the database after this moment. If no start time is specified, the end time of the previous run is used as the start time. An end time input specifies an end time and date for the batch processing run. For example specifying the current time causes processing of all transactions before that moment. If an end time is not specified, the current time is used as the end time. The run batch function 418 specifies an output value corresponding to the end time. This value can be used as the start time for the next run batch function or server run. Exceptions include: an incorrect server ID, the server is already running, the start time is after the current time, and no start time was specified for a function that corresponds to a first run of the server.

When providing the run batch function, one must consider the relationship between a server and a store. The store determines the periods within which it stores the data. So one cannot simply expect all changes from a batch run to be stored in one period. Also note that if retrieval starts while a batch is running, the period may be frozen. Therefore the results of the batch will be stored in two periods. If the run batch function 418 is provided, then systems designers must determine how to deal with a specified start time, because periods must be sequential, and the store will update old/frozen periods if necessary (e.g., depending on the commit time).

Rewinding a net change server or running in batch mode will have a consequence for the store. More specifically for the store functions described herein below with reference to FIG. 14 AddTransaction and Signal. When a transaction ID is less than or equal to the highest transaction currently in the store, one can consider overwriting the old data and deleting all data on higher transactions as well. This might mean periods that have already been frozen and/or retrieved will potentially be overwritten. The system should preferably ensure that periods are sequential, and the retrieval interface will not experience problems resulting from the rewind and batch functions.

Yet another API for the server is one that enables retrieving exceptions on a net change server. Such an API allows viewing of exceptions by external clients. In this case yet another API is provided to add a function for retrieving the identity of the net change server that fills a store, because the retrieve interface is unaware of a particular server that filled the store from which net changes are retrieved.

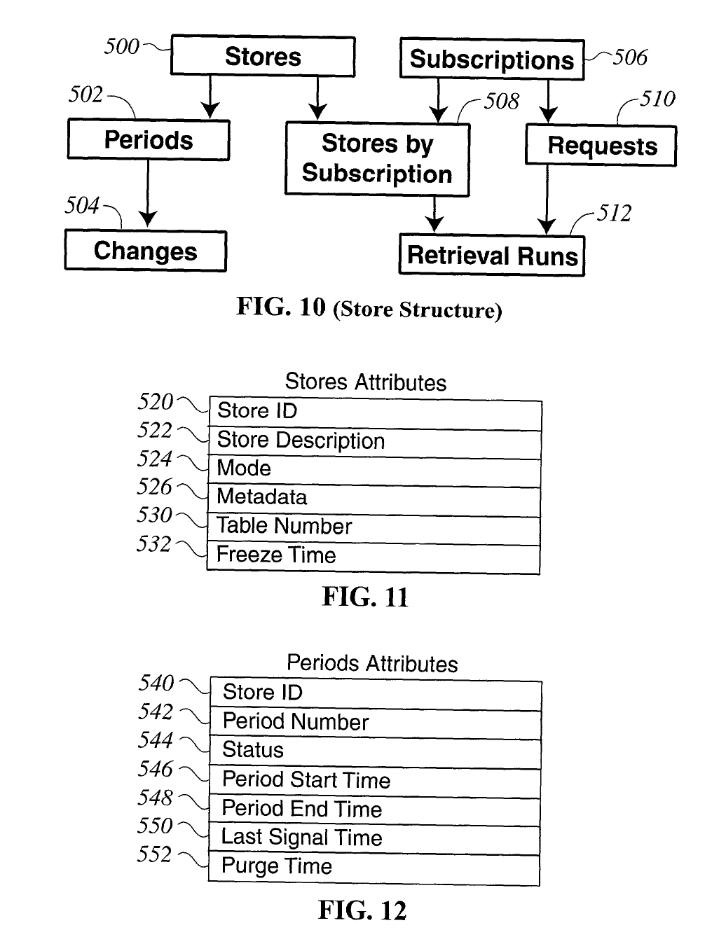

Having described data structures and a set of functions comprising the net change server and its associated application program interface, attention is now directed to FIG. 10 that identifies the structure/arrangement of the store 212 and a set of functions comprising the I-store interface 214 for the store 212 of FIG. 4. Each arrow connecting an identified component represents a potential one-to-many relation between connected components. A store 500 is, by way of example, an object containing all changes or net changes on a business object. The store 500 has two aspects. The first aspect concerns storing changes and/or net changes. Associated with this aspect of the store are a period 502 and changes 504 entities. Each instance of the period 502 refers to a time interval in which changes or net changes for a specific store are stored. When storing changes instead of net changes, then the period is not necessarily needed because each change is stored as a new change. However, periods are needed when storing net changes because when a new change is received the net change server should not combine it with a previous change that has already been retrieved by the client. Changes refer to either the changes or net changes on a business object, stored during a specified time period with which the changes are associated.

The second aspect concerns retrieval of the stored changes by external applications. The retrieval aspect of the store records transmission of requests for changes and maintains a record of how the requests are related. Entities pertinent to retrieval include: subscriptions 506, stores by subscription 508, requests 510 and retrieval runs 512. An instance of subscriptions 506 represents a group of stores that contain interrelated data for which the retrieval must be synchronized. A client can have multiple subscriptions. It is advisable to keep subscriptions small, because it is no use to have a subscription containing stores for which data is not (or does not need to be) synchronized. The stores by subscription 508 contains the stores that are included in a subscription. The requests 510 contain the retrieval of (net) data change objects for all stores in a subscription, by a specific client. If at least one of the stores in a subscription contains net changes, then one complete period will be retrieved. In other cases any time interval can be used. Thus, data from multiple periods may be retrieved per request, and a request will not result in freezing one or more periods. The retrieval runs 512 contains information corresponding to the actual retrieval of data for one request from one store. Per request, there can exist multiple retrieval runs for a store. For example, new/updated objects can be retrieved, and in a next run deleted objects are retrieved. Or a run may not complete successfully, in which case it has to be repeated, resulting in a new retrieval run for the same request.

It is again noted that in an exemplary embodiment of the invention a store holds one type of object. It holds either sales or order items, but not both—unless sales are stored as subordinate information to an item. In an alternative embodiment, a store may simultaneously hold multiple types of business objects. Each of the above entities of FIG. 10 are discussed herein below.

Turning now to FIG. 11, a set of attributes are provided for a store 500 entity. Each store 500 includes a store ID 520 that stores a unique identification value for the store object. A store description 522 provides a logical name or description for the store object. A Mode 524 stores a value designating that the store contains either changes or net changes. As mentioned above, a changes/net changes designation determines whether the change data is stored as changes (meaning each change is logged separately) or net changes (meaning subsequent changes for the same store are merged with already existing changes). A metadata attribute 526 stores metadata for the objects. The stored metadata identifies the tables (business object and subordinates) involved and the primary key for each table. The metadata facilitates creating net changes from change data. The store must be able to determine whether two changed entities actually are the same by comparing the values of the primary key fields. The primary key fields are defined within the metadata. A table number 530 stores a sequence number of the table that stores changes for the store 500. A freeze time 532 stores, in case of changes, a time after which a period must be frozen. If a store contains net changes, the periods are frozen on request, i.e. each time a client requires the next data set. If a store contains changes, the periods are not frozen on request, but after a predefined time interval, which is the freeze time. In the latter case the period cannot freeze on request because there may be multiple clients.

The server 500 uses the metadata to perform ‘netting’ of changes when the same row is changed multiple times within a transaction. However, the metadata can be different, because the entities and attributes that trigger the server can be different from the entities and attributes that are eventually sent from the server to the store. In most instances the server metadata is a subset of the store metadata. The server metadata is accessible to clients via a function in the library specified for the server.

Turning to FIG. 12, a set of attributes are provided for a period 502 entity. A store ID 540 provides a unique identification of the store with which the period is associated. A period number 542 stores a sequence number identifying the period. A status 544 includes a value indicating whether the changes associated with the period are free, frozen, or purged (the changes in this period have been cleared). Additional states added to facilitate synchronization storing and retrieving of changes include: writing, waiting for lock, and locked. A period start time 546 specifies, for the first period, a time of the first signal or the commit time of the first transaction received (whichever comes first). For subsequent periods, the period start time 546 specifies the end time of the previous period, plus one. The period start time 546 attribute facilitates ensuring that all transactions stored within the period have a commit time greater than or equal to the period start time. A period end time 548 stores a value specifying the end of the period. All transactions stored within the period have a commit time less than or equal to the value stored within the period end time 548. If an end time is set this doesn't mean the period is already frozen. For stores containing changes an end time is set as soon as the period entity is created for the store object. A last signal time 550 specifies the last time the net change server indicated completion of processing all transactions up to (but not including) that time. The last signal time 550 attribute contains the commit time of the last transaction stored, if this is greater than the last signal time. A purge time attribute 552 stores a date and time the period state was changed to “purged.”

A period is identified by a unique store ID and Period Number combination. The following constraints are associated with an embodiment of the store. A store ID must exist in store objects. If period n has status purged then for all p [symbol] n: status of period p is purged. In other words: a period can only be purged if all previous periods are purged. Furthermore, for all p [symbol] number of periods: status of period p is either frozen or purged. In other words: only the last period can have a status other than frozen or purged. A status of “waiting for lock” or “locked” can only occur if the store contains net changes, not if it contains mere changes.

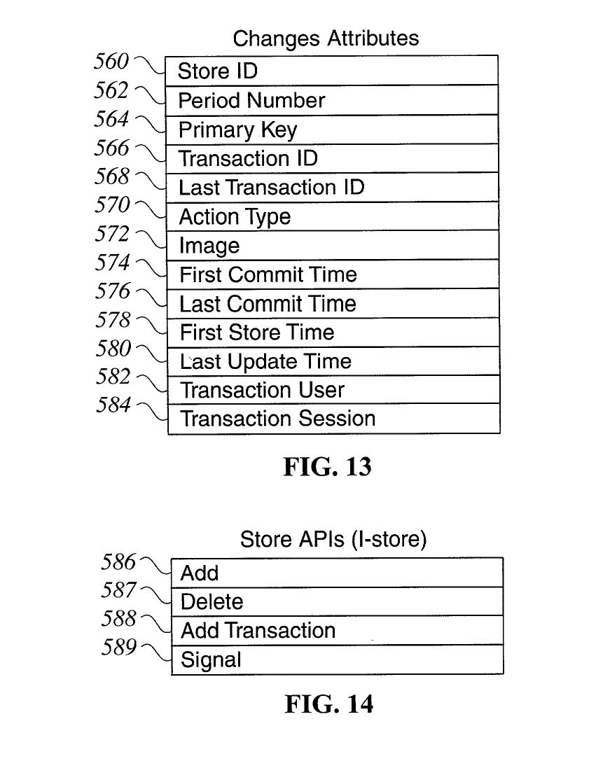

Turning now to FIG. 13, a set of attributes are depicted for changes stored for a particular period of a store object. A store ID 560 attribute and a period ID 562, in combination, uniquely identify a period with which a set of changes are associated. A primary key 564 stores a primary key value of the business object affected by the change. The stored primary key is the primary key of the top-level entity for the business object associated with the change. The primary key 564 is used for both changes and net changes because multiple business objects are capable of being changed within a single transaction. Note that a change may contain repeating groups (e.g. an order having multiple order lines). Thus one must ensure that every (net) change refers to a single business object (e.g. an order). Therefore, if the business object is an ‘order’, a primary key will not be provided for the order lines; the primary key will contain the order number.

A transaction ID 566 stores a value corresponding to a (first) transaction for a store in which a business object was changed. The transaction ID 566 is utilized because, when storing changes, the same primary key may occur multiple times. The transaction ID 566 is not necessary for net changes. However, the transaction ID 566 is filled with the ID of the first transaction updating this object in a period. The transaction ID 566 value is also used to determine the sequence in which (net) changes are retrieved. A last transaction ID 568 stores a identification of the last transaction for the store in which the business object was changed. In the case of storing changes, the last transaction ID 568 is equal to the first Transaction ID.

Another aspect of the net change server embodying the present invention is the inclusion of a description of an action type taken upon a database entry during a transaction. Such action is memorialized in an action type 570 attribute. The value stored in the action type 570 attribute describes the (net) action performed on the business object with regard to a prior state of the database object. Action types include “insert” (a new object was created), “update” (an existing object was updated) or “delete” (an object was removed). The action type need not be equal to the action type of the original database transaction. For example, if a new order line is created for an existing order, the action type will be “update” for the order business object. If an order is in a way such that the before image was inside the range specified in the Filter Function, but the after image is out of that range, then the action type will not be “update,” but instead will be “delete.” The action type of a change (ATC) is directly related to the action type of the top-level entity in the Image (ATI). If ATI=insert then ATC=insert. If ATI=delete then ATC=delete. If ATI=update or unchanged then ATC=update. Further examples of actions and their use in the context of net changes are provided herein below.

An image 572 stores a before and after image of the object in XML format. If Action Type=“insert” then the before image is empty, and if Action Type=“delete” then the after image is empty. The image 572 for a change need not contain all attributes. The image 572 includes the primary key attributes for each tuple and the changed attributes, but it may also contain attributes that have not been changed.

A first commit time 574 stores a date/time at which a transaction containing the first change on the business object in this period was committed to the OLTP database. A last commit time 576 contains a date/time at which the transaction containing the last change on the business object in this period was committed to the OLTP database. In case of changes, the stored value equals the value in the First Commit Time 574, because each change is stored separately. A first store time 578 stores a date/time at which the change was stored, e.g., a date/time in which this change was created. A last update time 580 stores a date/time at which the change entity was updated. In the case of changes this will be equal to the first store time, because only in case of net changes will existing changes be updated when new changes on the same object are coming in. A transaction user 582 stores, in the case of changes, the user that executed the transaction on the OLTP database. In the case of net changes, the transaction user 582 attribute is not filled. A transaction session 584 stores, in the case of changes, the session that executed the transaction on the OLTP database. In the case of net changes, the transaction session 584 is not filled.

It is noted that with respect to changes 504, there exists a need to distinguish between commit time (when the transaction was committed) and store time (when the change was stored in the integration table). Otherwise data will be lost. For example a change committed at 10:30 might not be stored until 10:55, depending on the frequency at which the net change server is running. When the client has retrieved data at 10:40, the server must realize that in the next run it shouldn't read transactions committed in the OLTP database after 10:40, but rather transactions stored after 10:40. However, to ensure this the server actually does not use the store time, instead the server ensures that a request for data has a start commit time that is immediately after the end commit time of the previous request.

Each change instance is uniquely identified by a store ID, period Number, primary Key, and transaction ID combination. The server uses the (first) transaction ID for the identification, and not the last transaction ID, because otherwise the server would have to update the primary key of this relation (i.e. delete the row and create a new one) when storing net changes.

Normalization of stored changes is now discussed. If the server stores only changes or only net changes, two relations can be created. In the cases of changes an entry would include the following relations between a transaction and a corresponding stored change object:

Transaction (store ID, period number, transaction ID, store time, commit time, user, session).

Changed object (store ID, period number, transaction ID, primary key, action type, image).

In case of net changes the relationships would be rendered as follows:

Changed object (store ID, period number, primary key, net action type, net image).

Transaction (store ID, period number, primary key, transaction ID, commit time, store type, user, session).

Combining these results in the following entry for a change:

Transaction (store ID, transaction ID, store time, commit time, user, session).

Net change (store ID, period number, primary key, net action type, net image).

Change (store ID, period number, transaction ID, primary key, action type, image).

Turning now to FIG. 14, a set of functions are identified to facilitate interfacing the net change server 202 to the store 212 in a net change server system of FIG. 4 embodying the present invention. The I-Store interface 214 includes an add function 586 that facilitates adding a new store to handle changes submitted by the net change server. The add function 586 is called with a store identification to be used to distinguish the new store, a description (text) generally describing the new store, a mode (indicating whether changes or net changes are stored). The mode determines whether the change data is stored as changes (meaning each change is logged separately) or net changes (meaning subsequent changes for the same store are merged with already existing changes). Metadata for the objects is also included in the input. The metadata identifies the tables (business object and subordinates) that are involved and the primary key for each table. The metadata is preferably rendered in XML format. A table number included in the input is provided, by way of example, as a sequence number of the table to be used for storing the changes. The last input is a freeze time (in the case of changes) that indicates a time period after which input to the store is frozen. If the freeze time is not specified, then the store input is stopped when a maximum file size is reached. The add function 586 does not return an output value. However, an exception is returned in the case where the specified store ID already exists.

A delete function 587 deletes a store component. When deleting a store, first the associated periods, changes, stores by subscription and retrieval runs are purged, then the identified store is deleted. If the delete function 587 is executed via a user interface a warning is given when a store is used in a subscription. A store ID is input to the delete function 587 and no output value is rendered. Exceptions returned include, by way of example: an incorrect store ID was specified or a client request is presently being executed by the specified store.

An add transactions function 588 adds a transaction to the store. If necessary, then this function creates a new period. Examples where such necessity arises include if no period exists or the highest period is frozen, or changes are stored as changes (and not as net changes) and the freeze time has passed. Input parameters to the add transaction function 588 include: a store ID, a transaction ID, a commit time, a number of (business) objects changed. Also the following are included for each object involved in the transaction: an action type (insert—a new object, update—a changed object, or delete—a removed object), a primary key, and a pointer to an XML object containing the before and after image of the changed object. The add transactions function 588 has no output parameters. However, the add transactions function 588 returns an exception when an incorrect store ID (the store may have been deleted) is submitted or if the transaction ID is too low (the same or newer transactions already exist in the store).

A signal function 589 facilitates informing an identified store that all transactions up to a specified commit time have been sent to the store. The signal time must be greater than or equal to the commit time of the last transaction sent to the store. When the server 202 starts, the server 202 must send a signal having a value for the signal time equal to the start commit time of the server (which is not the current time, but rather the start commit time as specified by the user when starting the server). When a server is adding transactions to the store these transactions are sufficient to determine the status of the server and the store. Therefore the signal function 589 is not required. However, when there are no transactions to be processed, the server 202 uses the signal function to indicate to the store 212 that the server 202 is still running and to tell the store how far the server has progressed in processing transactions. If no signal is sent to the store and no transactions are received, the store will not be able to find out whether the end time of a period has already been reached, and the store may not be able to freeze a period.

Input parameters to the signal function 589 include a store ID and a signal time indicating that the server has processed all transactions having a commit time less than the signal time. The signal function 589 has no outputs, but will return an exception if an incorrect Store ID (the store may have been deleted) is submitted or a signal time is less than a highest signal time already available or highest commit time already processed.

The following are further enhancements to the store 212. The first enhancement concerns synchronization optimization. To synchronize I-Store and I-Retrieve interfaces, a semaphore mechanism in shared memory is provided. In an embodiment of the invention, the state of the periods entity is used, but this approach creates a large amount of overhead. Furthermore it interferes with the transaction handling, because the net change server system needs to commit within the logical transaction. When using shared memory, the values Writing, Waiting for Lock, and Locked are no longer needed by a status of the period entity.

With regard to a time range for retrieving net changes, in an embodiment of the present invention, the commit time range is not used when at least one store in a subscription contains net changes. However, the commit time range can also be used for net changes. In that case the commit time range would work as follows. The actual start would be the start of the period that contains a specified “commit time from” value. The actual end would be the end time of that period. If the “commit time from” value is less than the “start time” of the first period, then the start and end of the first period are used.

Having described attributes and entities associated with storing changes in a store and a set of functions interfacing the store to a net change server, the description of the present invention is now directed to data change object retrieval entities and attributes depicted in FIG. 10. By way of introduction, retrieval preferably includes logging and status monitoring. One of the reasons for this is purging. Usually a period can only be purged after every client completely processes it. In the case of changes, a net change server system can have multiple clients per store, so in that case the server/store needs to know the status for each client. However, the client is not known explicitly. The exemplary NetList implementation allows the client to be anonymous. The client itself keeps track of the status. Because the store does not know the client, subscriptions are utilized by the store to define clients, and request numbers are used to identify client requests for a subscription. In subsequent requests, a client can refer to a previous request, either to repeat it or to start where the previous request ended. This way the store can logically group requests by client.

A client application may need data from multiple stores. If the client application needs related data like items and sales orders, then if net changes are stored, the current period for both stores must be frozen synchronously. In all cases the client application uses a single request number for a range of stores. The single request number guarantees that for each store the client will receive the same range of data. Stores that need to be synchronized are grouped in a subscription.

If a subscription contains more than one store containing net changes, then the period freeze for those stores are synchronized. For each two stores within a subscription the period boundaries (start time and end time) are the same. In other words, for each set of stores S1 and S2 within the same subscription, the lowest transaction of period n in store S1 is greater than the highest transaction of period n−1 in store S2, and the highest transaction of period n in store S1 is less than the lowest transaction of period n+1 in store S2. A store is used in one subscription at a time if the store contains net changes. A store containing net changes is used by one client, and also a subscription is used by one client. The subscription structure also allows the client to retrieve deleted objects and new/changed objects for interrelated business objects separately. For example a subscription may specify: first retrieving new/updated items, then retrieving new/updated orders and deleted orders, and then retrieve deleted items.

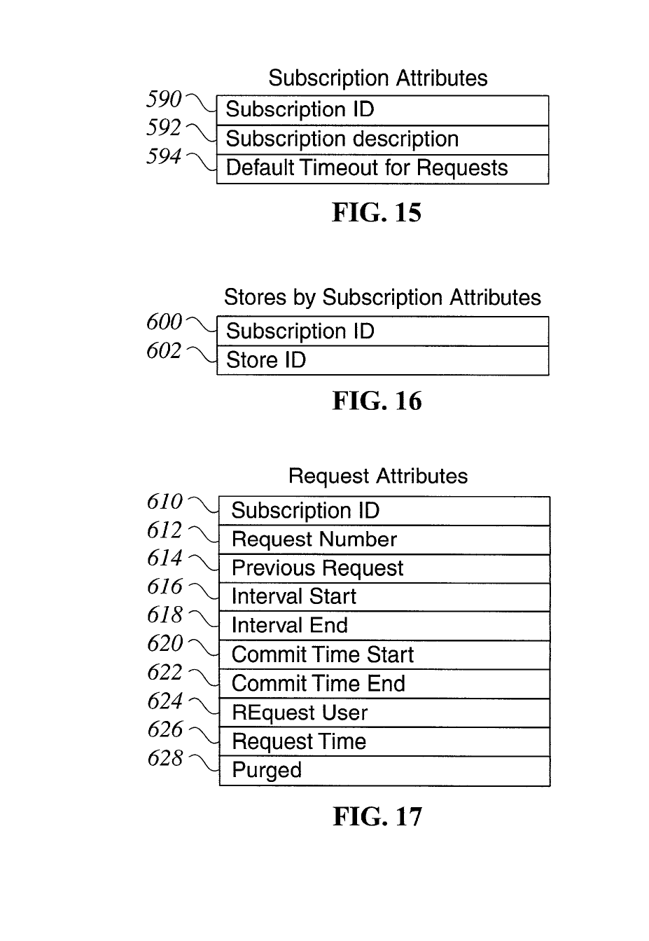

Turning to FIG. 15, a set of attributes are provided for a subscription 506 of FIG. 10. A subscription ID 590 stores an identification of the subscription. A subscription description 592 stores a logical name or description for the subscription. A default timeout for requests 594 stores a value corresponding to a default maximum time (in milliseconds) the process will wait for periods to be closed when creating a new request. The default timeout value can be overruled by a parameter of a function NewRequest associated with the retrieve interface of a store. A subscription is identified by subscription ID.

Turning to FIG. 16, stores by subscription 508 include attributes that facilitate identifying a particular subscriber store. A subscription ID 600 references a subscription, and a store ID 602 references a store. The two attributes are combined to uniquely identify a subscription for a store. A number of constraints are recommended for the stores by subscriptions attributes. The store ID must exist in the stores 500. If the store has mode “net changes,” then it can only be in one subscription. If the subscription contains more than one store containing “net changes,” then the start and end times for the periods for each of those stores must be the same. A subscription ID must exist in the subscriptions 506. Depending on the existing requests, adding or removing stores to a subscription can be a problem. If no request exists for a store, then the subscription can be updated by adding or removing stores. If one or more requests exist, a store containing net changes to the subscription cannot be added, because the intervals of the requests and the period start/end of the store will be conflicting. Because a request refers to a single time interval and in the case of net changes the server system can only retrieve complete periods, the start and end times of the periods for each store containing net changes must be the same. If they are not, the server system cannot determine a valid time interval for the request and consequently cannot retrieve data. In all other cases removing or adding stores is possible, but a warning is given. The following TABLE C describes handling requests for adding stores to a subscription depending upon whether requests exist.

TABLE C

| | Add store | Remove store | Add store | Remove store |
|---|---|---|---|---|
| Request | containing net | containing net | containing | containing |
| exists | changes | changes | changes | changes |
| No | (a) | OK | OK | OK |
| Yes | Not possible | Warning (b) | Warning (b) | Warning (b) |

With regard to the table notes:

(a) Usually adding a store containing net changes is not a problem when no request exists. However, the user can remove a store containing net changes from one subscription and add it to another one (e.g., splitting a subscription into two subscriptions because some business objects need to be retrieved at a higher frequency). Removing a store creates a problem, because in that case the store may already have one or more frozen periods. The problem becomes more severe if the server/store does this for multiple stores containing net changes, because in such cases the stores may not be synchronized. In summary: if the store that is added already has one or more frozen periods then: (1) a warning is given if there are no other stores containing net changes in the subscription, and (2) an error is produced if there are other stores containing net changes in the subscription. If this is acceptable from a performance perspective, then the error can be replaced by a warning if the subscription already contains one or more stores having net changes, but the periods for those stores have exactly the same start and end times as those of the store to be added. This is the case when moving multiple stores from one subscription to another.

When moving a store to another subscription is inhibited, there is a work-around for the user. The user can always decide to stop the server, switch to another store, and then start the server again.

(b) The warning states that the subscription is already in use by a client application, and changing the subscription will impact the client application.

Turning to FIG. 17, requests 510 include attributes that facilitate identifying a particular request to receive changes from the net change server store by a particular client. A subscription ID 610 references a subscription. A request number 612 stores a sequence for a request. In the case of net changes, the period will typically be equal to the request number. A previous request 614 stores a value identifying the previous request. If filled, the value represents the previous request of the client, and the end of this request is the start of the current request. If filled and at least one store in the subscription contains net changes, then the previous request 614 stores a value equal to the Request Number minus 1. An interval start 616 stores a value that, in the case of a “changes” mode of operation, represents a commit time from (and after) which changes are requested. An interval end 618 stores a value that, in the case of a “changes” mode of operation, represents a commit time up to which changes are requested.

A commit time start 620 corresponds to an actual interval start as determined by the retrieval interface based on the previous request 614 or the interval start 616. If all stores in the subscription contain changes, then the value in the commit time start 620 will be equal to the value stored with the interval start 616 because a start time requested by a client application can be used. If one or more stores contain net changes, the value stored within the commit time start 620 will be the period start time 546 of the period for which data is returned. In that case the start time requested by the client application cannot simply be used because all data from a period is sent. A commit time end 622 stores a value representing the actual interval end as determined by the retrieval interface based on the previous request or the interval end 618. If all stores in the subscription contain changes, then this will usually be equal to the interval start 616, but it may be corrected if the highest commit time or the highest signal time for a store is less than or equal to the interval start 616. It is noted that when changes are stored, any commit time interval can be requested. However, if the end of the commit time interval is close to the current time, then there is a risk that transactions received prior to the commit time have not yet been processed by the server 202. For that reason, correction of the interval end 618 is needed if one or more servers involved in a request are backlogged. Furthermore, if one or more stores contain net changes, the commit time end 622 will be the period end time 548 of the period for which data is returned.

A request user 624 stores a value corresponding to a client/user (e.g., the BaanERP user) that initiated the request for changes. A request time 626 stores a value representing a time at which a particular instance of the requests 510 was created. A purged attribute 628 stores a value indicating whether the change data returned by this request has been purged. A purged value does not always mean the periods the purged attribute refers to have also been purged, because purging will only occur if for all clients a period has been purged, or a period has been purged globally. The I-purge interface functions are described further herein below.

A unique request is identified by a combination of values stored within the subscription ID 610 and request number 612. The following exemplary constraints are applied to requests: a subscription ID must exist in the subscriptions, and a subscription ID and previous request value must exist in the requests.

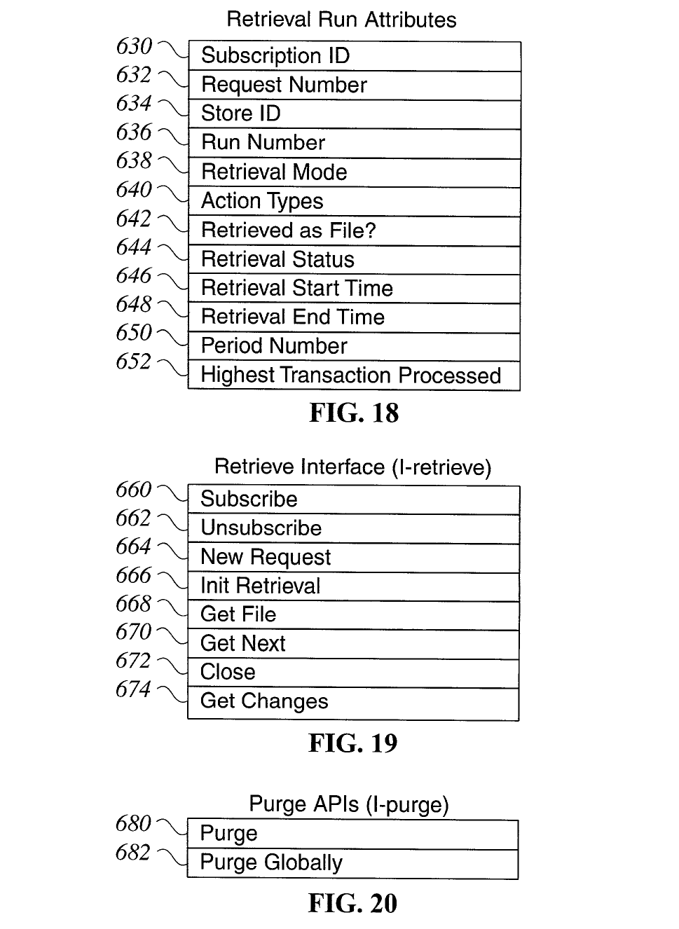

Turning now to FIG. 18, a set of attributes are depicted for instances of the retrieval runs 512. A subscription ID 630 and a request number 632 store values that, in combination, uniquely identify a request with which a retrieval run is associated. A store ID 634, in combination with the subscription ID 630 value refer to a particular one of the stores by subscription 508. A run number 636 stores, for example, a sequence number assigned to a run for the store identified within the request. A retrieval mode 638 stores a value indicating whether the retrieved information represents changes or net changes. An action types attribute 640 identifies the types of actions for which changes are retrieved during a particular retrieval run. The action types designated by the action types attribute 640 are, by way of example, constrained to: only new and changed objects, only deleted objects, or all objects. This is required if a client application needs data from multiple business objects that are interrelated. For example, first retrieve new/updated items, then retrieve new, updated and deleted orders, then retrieve deleted items.

Continuing with the attributes for retrieval runs 512, a retrieved as file 642 stores a value indicating (yes/no) whether the file for the period was retrieved as a whole file or whether the net changes were retrieved via the interface one by one. A retrieval status 644 stores a value indicating whether the retrieval run is either initialized or closed. An “initialized” status is assigned when the retrieval run is created. A “closed” status is rendered when a close function in the retrieve interface (described herein below) is called. A retrieval start time 646 stores a value corresponding to a time at which the particular instance of the retrieval runs 512 was initialized. A retrieval end time 648 identifies a time at which the retrieval run was completed or the retrieval status was last updated. A period number 650 stores a value that, in the case of net changes represents the period for which the changes are retrieved. If changes are stored, rather than net changes, then no period number is provided. A highest transaction processed attribute 652 stores a value representing the progress of a particular retrieval run. If the changes were not retrieved as file, then the value stored in the highest transaction processed attribute 652 corresponds to the last transaction for which the change has been read by a requesting client. If the changes are “retrieved as a file”, then this attribute contains the highest transaction stored in the retrieved file.

Additional attributes added in alternative embodiments of the invention include: attributes specifying a transaction ID, a commit time and store time of the first transaction returned, and a commit time and a store time of the last transaction returned.

A particular retrieval run instance is uniquely identified by combination of values from the subscription ID 630, the request number 632, the store ID 634, and the run number 636. The following constraints are placed upon the retrieval run attributes: a subscription ID and request number must exist in requests 510, a subscription ID and store ID must exist in the Stores by Subscription 508, and if the period number is filled then a store ID and period number must exist in Periods 502.

Having described a set of database entities associated with retrieving changes from the store 212, attention is now directed to FIG. 19 that identifies a set of functions comprising the I-retrieve interface 216 that facilitates retrieval of changes (net changes) by client applications. A subscribe function 660 creates a new subscription for one or more stores. The input parameters include: a subscription ID, a subscription description, default time out, and a store ID for each store included in the subscription. The subscribe function has no output parameters. However, the following exception conditions are flagged: an incorrect subscription ID (e.g., already exists), one or more store ID values are incorrect (do not exist), or one or more stores containing net changes are already used in another subscription. It is noted that a store can be present in more than one subscription if it contains single changes (i.e., each change is stored separately rather than combining multiple changes). If the store contains net changes (i.e., by combining multiple changes on the same business object), the store can be used in only one subscription. In the latter case only one client can use the store because the moment the client asks for the next set of net changes determines the changes combined into a net change—a change will only be combined with an earlier change if the earlier change has not yet been retrieved by the client. Multiple clients would result in conflicting decisions on whether to combine changes.

An unsubscribe function 662 deletes a subscription as well as the stores by subscription, requests, and retrieval runs associated with the subscription. The only input parameter is a subscription ID value identifying the subscription to be deleted. The unsubscribe function 662 has no output parameters, but creates an exception when the identified subscription does not exist. Additional interface functions are provided for adding and removing stores from a subscription.

A new request function 664 performs any initialization required for reading (net) changes and provides an ID for retrieving the changes from a specific store (see, the function Init Retrieval 666 below). For stores containing net changes the current period is frozen if required. The new request function 664 supports a number of input parameters including a subscription ID. A Previous Request, if provided, contains the previous request number of a client. The end of this request is the start of the current request. If net changes are stored and the Previous Request returned period “n,” then the current request will return period “n+1.” If changes are stored and the Previous Request returned the interval “t1-t2,” then the current request will return the interval t2 minus the current time. In general, the retrieval will start directly after the last transaction returned by the specified Previous Request. If the Previous Request parameter is not filled this is the first request of a client; when stored as net changes the highest period will be used (which usually is the first period), when stored as changes the commit time range (Commit Time From/To) will be used.

A Commit Time From parameter specifies a start of the commit time range for (net) changes to be retrieved. This is only used when no Previous Request is specified and all stores within the subscription contain changes. A Commit Time To parameter specifies an end of the commit time range for (net) changes to be retrieved. This is only used when a Previous Request is not specified and all stores within the subscription contain changes. A Timeout parameter specifies a maximum time (in milliseconds) the process will wait for periods to be frozen when creating a new request. If not specified, then the default timeout of the subscription is used.

A number of output parameters are rendered by the new request function 664. A Request Number is rendered that is used, for example, to retrieve (net) changes, and to retrieve subsequent data sets or the same data set again in the future. A Commit Time From output parameter specifies an actual start of the commit time range that is returned. The Commit Time From value may differ from the commit time specified as an input parameter when the subscription includes stores containing net changes, because in that case only a complete period can be returned. So if all stores in the subscription contain changes, then the Commit Time From output value will be equal to the Interval Start. Furthermore, if one or more stores contain net changes, then the Commit Time From output value will equal the Period Start Time of the period for which data is returned. A Commit Time To output parameter corresponds to the actual end of the commit time range that is returned. The Commit Time To output value may differ from the specified commit time specified as input parameter. The Commit Time To is preferably never greater than the current time. Furthermore, if one or more stores are not completely up to date, the Commit Time To value is corrected. In such a case, the status of the store having the greatest backlog determines the Commit Time To value. When the subscription includes stores containing net changes only a complete period is returned. In that case the Commit Time To value is equal to the Period End Time 548 of the period for which data is returned. A Warning Flag output parameter is set if a new request is created, but all data for the previous request has not yet been retrieved successfully.

In addition to output parameters, the following exceptions are rendered by the new request function 664. A subscription ID incorrect exception is rendered is the identified subscription does not exist. A Previous Request incorrect exception indicates that no such request exists. An exception is rendered if the specified Previous Request is not specified, but one or more requests already exist for the subscription because this may indicate multiple clients are using the same subscription. An exception is rendered if at least one store contains net changes, and the specified Previous Request is not the last request for this subscription, because trying to create multiple requests for the same range of data is not allowed if a store contains net changes. Yet another exception is rendered if one of the stores for the subscription has an idle state (i.e., it doesn't contain any data or signal). If for one or more stores not a single period exists, then the creation of a new request will fail immediately. In that case the status of the store cannot be determined because no server has ever been running for that store, and nothing can be retrieved. An exception is rendered in response to a timeout. In such case one of the periods could not be frozen or a server may not be running. A timeout exception may also arise from a previous attempt to create a new request that returned a timeout, and the status of the request has not been changed. In such a case, the end time for one of the stores containing net changes was already set but still the period has not been frozen. In the case of a timeout exception, the next time Retrieve.NewRequest( ) is called the same commit time interval will be used. An exception is also created in the event that a Commit time range is incorrect. Fore example, a Commit Time From that is greater than a “current time,” or a Commit Time To that is less than a commit time of first change in store will result in an exception condition.

An Init Retrieval function 666 performs any initialization required for reading (net) changes. The Init Retrieval function 666 specifies whether changes or net changes are retrieved and what action types must be included (new and changed, deleted, or all). After executing this function successfully, the changes can be retrieved using GetNext( ) or GetFile( ) functions described herein below. Input parameters for the Init Retrieval function 666 include: a subscription ID, a Request Number, a store ID, Action Types (indicating whether to retrieve new and changed objects, deleted objects, or all objects), and a Retrieval Mode (indicating whether to retrieve as changes or net changes).

The Init Retrieval function 666 does not provide any output parameters. However a number of exceptions are noted. Potential exceptions include: Subscription ID incorrect if the identified subscription does not exist; Combination of Subscription ID and Request Number incorrect if the identified request does not exist; Store ID incorrect if the store does not exist in the subscription to which the request belongs; requested data has been purged; and cannot return as changes (when stored as net changes).

A get file function 668 copies the file containing the net changes for the period or the changes for the interval to a specified location. If required, the changes in the interval specified in the NewRequest function 664 are netted. The Mode specified in InitRetrieval function 666 determines the retrieval sequence. In “changes” mode the changes will be presented ordered by transaction ID and primary key. In “net changes” mode the order will be undetermined. When the store contains net changes, the file is simply taken from one period. When the store contains changes, the file is created, for example, by combining (parts of) files from one or more periods. After calling the get file function 668 and receiving the file successfully, a close function 672 is called.

Input parameters to the get file function 668 include: a File Name identifying where to store the file (host, path, and filename). No output parameters are rendered. However, a number of exceptions are returned including: Not initialized if the InitRetrieval function 666 was not previously successfully called prior to the get file function 668 call; error when reading store; error when creating file; and error on copying file.

A get next function 670, if called for the first time, provides the first (net) change of the period or time interval specified in the NewRequest function 664. On subsequent calls for the same Retrieval ID, the NewRequest function 664 provides the next (net) change, until no more net changes are available for the period. The Mode specified in the InitRetrieval function 666 determines the retrieval sequence. In the “changes” mode the changes will be presented ordered by transaction ID and primary key. In the “net changes” mode the order will be undetermined. After calling the get next function 670 a number of times and having received the last change successfully, the Close function 672 is called.

The get next function 670 has no input parameters. Output parameters include: a Primary Key (converted to a string) of the object; an Action Type; an Image structure containing the before/after image in XML format; a Transaction ID; a Last Transaction ID; a First Commit Time; a Last Commit Time; a First Store Time; a Last Update Time; a Transaction User (only when retrieving changes, not when retrieving net changes); and a Transaction Session (only when retrieving changes, not when retrieving net changes). Exceptions returned by the get next function include: “not initialized” if InitRetrieval 666 was not successfully called before issuing the get next function 670 call; “No more changes”; and “Error on reading store.”

The close function 670 marks completion of a retrieval run. The function does not ensure that all changes were actually retrieved—that responsibility is placed upon the requesting clients. The close function 670 has no input or output parameters. An exception is rendered by the close function 670 if the retrieval was not previously initialized—i.e., Init Retrieval function 666 was not successfully called prior to the close function 670 call. It is noted that with respect to output parameters, rather than issuing output in response to every get next function 670 call, output parameters such as “highest transaction id processed,” or “lowest and highest commit time” or “lowest store time and highest update time” are rendered as output from the close function 670.

The get changes function 674 combines the functionality of the InitRetrieval function 666, the GetNext function 670, and the Close function 672. However, the get changes function 674 has two limitations. It doesn't return any parameters for individual changes that are not in the XML image. On the other hand, the GetNext function 670 does return such parameters. Furthermore all data is output as a single chunk. Thus, the available internal memory of the computer system limits the amount of data that can be retrieved using the get changes function 674.

The input parameters of the get changes function 674 include: a Subscription ID; a Request Number; a Store ID; Action Types (e.g., designating whether to retrieve new and changed objects, deleted objects, or all objects); and Retrieval Mode (e.g., designating whether to return as changes or net changes). The output parameters comprise a before/after image in XML format for each (net) change. Exceptions returned for the get changes function 674 include: “Subscription ID incorrect,” when a subscription does not exist; “Combination of Subscription ID and Request Number incorrect,” when a request does not exist; “Store ID incorrect,” when a store does not exist in the subscription to which the request belongs; “Data has been purged already;” “Cannot return as changes,” when changes are stored as net changes; “No changes;” “Error on reading store;” and “Too many (net) changes,” when the system runs out of memory due to an excessively large change file.

The following comprises an exemplary description of a process utilized by a client application to retrieve data change objects from the store 212 via the retrieve interface 216. In particular pseudo code provided herein below summarizes how the NetList 210 utilizes the retrieve interface 216 to pull relevant (net) data change objects from the store 212.

Before describing the pseudo code, a list of pertinent APIs are described. A function, Subscription.Subscribe( ), has the same specifications as the above described subscribe function 660 of FIG. 19. The Subscription.Subscribe( ) function is offered to client applications as a business object interface. Alternatively, client application sessions define a subscription. A function, Subscription.GetNewRequest( ), has the same specifications as the above described get new request function 664. The Subscription.GetNewRequest( ) function is offered to client applications as a business object interface. A BusinessObject.NetList( ) function includes the following input: Business object, Subscription ID, Request Number, Action Types, and whether to retrieve as changes or net changes. The BusinessObject.NetList( ) function is a standard NetList retrieval functionality of a business object interface. The output of this function includes a result set if the data change objects are not retrieved as file. The following comprises an exemplary pseudo code rendering of a process (without exception handling) for retrieving data change objects via the retrieve interface for the store.

BusinessObject.NetList(business object, subscription id, request number, action types,

[retrieve as file, target file])

store id = get store for business object(business object)
if Retrieve.InitRetrieval(subscription id, request number, store id,

net changes, action types) = OK then

while more data to retrieve

Retrieve.GetNext(transaction id, primary key, action type, image,

last transaction id, first commit time, last commit time,
first store time, last update time)

add retrieved object to result set, which is an XML tree

end while
Retrieve.Close()

end if.

The following is noted with regard to the above pseudo code. First, the BOI could internally retrieve the data change objects as file (even though the client application may not want to retrieve the changes as file), and read the data change objects from the file. Second, the store id could be equal to the business object, in which case the pseudo code could simply state: “store id=business object” rather than “store id=get store for business object(business object).” Third, if the action types argument is not yet implemented in the data change system, then all object will be retrieved rather than ones having a specified action type.

Synchronizing storing and retrieving is performed to ensure that data change objects provided to the store via the store interface 214 are properly retrieved via the retrieve interface 216. The store 212 has two interfaces, one for storing (writing) and one for retrieving (reading). When the store 212 contains net changes, a newly received request will result in the store 212 freezing the current period. Therefore, synchronization is needed between retrieval and storage, because the store 212 cannot freeze a period while change data is being written to the period.

A transaction is always stored in a single period. For example, if two sales orders are changed within a single transaction, both sales orders are stored in the same period. Otherwise a client application might retrieve half a transaction. Furthermore, when combining a data change object with an already existing (net) data change object, the new net change object is stored in the same period that contained the already existing data change object. Therefore, a period cannot be frozen while a transaction is being written, and the retrieve request should wait for the writing operation to the period to complete. After writing is complete, the store 212 freezes the period, and the next set of data change objects for a next transaction are stored in a next period.

The store 212 also controls storage and retrieval to ensure that a retrieve request does not wait for an unacceptably long period. In an embodiment of the invention, a pending retrieve invokes a request to freeze the period thereby allowing retrieval of data change objects to commence without the need for several retries (due to the store being in the process of receiving several transactions). Without the ability of a retrieve request to block storage of further transactions, a risk exists that at a subsequent attempt to retrieve data change objects the store will be busy writing a next transaction.

In an embodiment of the present invention, all stores within one subscription containing net changes are synchronized. Therefore, the period for each store in one subscription are frozen at a same point. The periods for multiple stores within a subscription all have the same Period Start Time 546 and Period End Time 548.

Synchronization also impacts the handling of single data changes objects and net data change objects. When storing changes the period is driven by a freeze time. The retrieval process never freezes a period, and freezing is always performed by the storing process. When storing changes a non-frozen period can be read. The ability to read a non-frozen period is especially important when the freeze interval is greater than the retrieval interval (e.g. freezing every hour but retrieving every 10 minutes). Retrieving data change objects from a non-frozen period does not present any problems because the retrieval status is not determined by period, but rather by last retrieved transaction.

Some precautions must be implemented in the case of net change retrieval to ensure the retrieved data change objects are synchronized. In the case of net data change objects, the retrieval process sets a lock for a range of stores and then sets an end time for those stores based on a highest commit time currently in those stores. After setting an end time, the retrieval process unlocks the periods. The retrieval process then waits until the store process freezes all involved periods before commencing reading the net data change objects.

Transactions may not be received by the store for a long period of time. An absence of incoming transactions might indicate the server is not running, but it could also simply indicate that no transactions have been executed on the specified tables. In view of the potentially long delays between transmissions to the store, each server 202 will send a signal to indicating that the server is operating properly and has finished processing all transactions up to a specified commit time. Based on that signal the store can freeze the period (if the signal time is greater than the period end time). If the server did not send such a signal, the store could not determine whether the server is still running.

In the case of both changes and net changes, a store cannot have transactions in two different periods having the same commit time. Thus, if period n contains a transaction having commit time t, then for all transactions in period n−1, the commit time is less than t, and for all transactions in period n+1 the commit time is greater than t.

Synchronization writing and reading a store also addresses timeout circumstances. When at least one store in a subscription contains net changes, there is a risk of timeout. The retrieval process waits for the store process to freeze the period. However if for example the server is stopped or asleep, the end time for a period will not be reached and the period cannot be frozen. A timeout means that for one or more stores an end time is set, but freezing was not completed. At the next request, the retrieve process returns data for the same period that already has an end time set. Finally, if for one or more stores not a single period exists, the creation of a new request fails immediately (even before starting to set the end time for other periods). In that case the status of the server will be unknown (and consequently of the store), and no changes can be retrieved in view of the unknown state of the periods.

Synchronization and locking problems can be avoided by the store by defining store states and their transitions. The states are determined by: the highest period, whether a server is currently writing, and whether a client is waiting for a period to be frozen. The store synchronization states are depicted herein below in TABLE D.

TABLE D

| | Highest period | Period end time | |
|---|---|---|---|
| Period exists | status | is set | State |
| No | — | — | Idle |
| Yes | Free | No | free & no end * |
| Yes | Free | Yes | free & end |
| Yes | Writing | No | writing & no end * |
| Yes | Writing | Yes | writing & end |
| Yes | waiting for lock | No | waiting for lock * |
| Yes | waiting for lock | Yes | (impossible) |
| Yes | Locked | No | locked * |
| Yes | Locked | Yes | (impossible) |
| Yes | Frozen | No | (impossible) |
| Yes | Frozen | Yes | Idle |
| Yes | Purged | — | Idle |

“*” Indicates a state that can only occur if the store contains net changes.

The above summarized states should be read in conjunction with TABLE E below to completely define the synchronization of reading and writing store data change objects. The state transitions are specified in the following TABLE E. TABLE E specifies the state transitions based upon a previous state and an action. The state transitions will differ depending on whether the store contains changes or net changes.

TABLE E

| | Previous state | | | | | | |
|---|---|---|---|---|---|---|---|
| | | Free & | Free & | Writing & | Writing | Waiting | |
| Action | Idle | no end | end | no end | & end | for lock | Locked |
| Changes | | | | | | | |
| start writing | Writing & | X | Writing | X | X | X | X |
| | end (a) | | & end | | | | |
| | | | (c) | | | | |
| Stop writing | X | X | X | X | Free & | X | X |
| | | | | | end | | |
| Freeze | X | X | X | X | X | X | X |
| request | | | | | | | |
| set end time | X | X | X | X | X | X | X |
| Signal | Free & | X | Free & | X | X | X | X |
| | end (a) | | end (d) | | | | |
| Net Changes | | | | | | | |
| start writing | Writing & | writing & | Writing | X | X | X | Locked (g) |
| | no end (a) | no end | (e) | | | | |
| Stop writing | X | X | X | Free & no | Free & | Locked | X |
| | | | | end | end | | |
| Freeze | Idle (b) | Locked | X | Waiting | X | X | X |
| request | | | | for lock | | | |
| set end time | X | X | X | X | X | X | Free & |
| | | | | | | | end |
| Signal | Free & no | Free & | Free (f) | X | X | X | Locked (g) |
| | end (a) | no end | | | | | |

TABLE NOTES:
(a) The first period is created.
(b) The freeze request will not succeed for this store. The server is not running and therefore no transaction data or signal was ever received.
(c) If the commit time of transaction is greater than the end time of period then the period is frozen and a new period is created. Depending on the freeze interval for the store more than one period may be frozen and created.
(d) If the signal time is greater than the end time the period is frozen, and a new period is created. Depending on the freeze interval for the store, more than one period may be frozen and created.
(e) If the commit time of the transaction is greater than the end time of period, then the period is frozen, and a new period is created (new state = Writing & no end), otherwise the state will be Writing & end.
(f) If the signal time is greater than the end time, then period will be frozen, and a new one will be created (new state = Free & no end). Otherwise the state will not be changed (Free & end).
(g) The store process will wait until the lock is removed by the retrieval process. After the lock is removed, the state is changed to free & end, and processing of the transaction or signal continues.

A new period is created immediately whenever possible. For example when a period is frozen (i.e. if the signal time or commit time is greater than the end time of the current period), the next period is created immediately. When a transaction or signal is received and the current state=Idle, then the first period is created. Because new periods are created immediately, new periods will be created if no transaction data is received—resulting in empty periods. But the policy of creating new periods is desired—especially when synchronizing multiple stores.

With regard to the issue of system performance, overhead of the synchronization steps must be low. For example, if a number of additional database actions are needed to ensure synchronization when storing a single transaction, then synchronization will weigh heavily upon system performance. For this reason, in an embodiment of the invention, a semaphore mechanism is implemented upon the read/write interfaces of the store. In an implementation where an optimized solution is not available, additional status variables are added to the period. Thus, a period will not merely include three possible statuses (open, frozen or purged). Instead the ‘open’ status is split into: free, writing, waiting for lock, or locked.

Having described the store and retrieve functionality of an exemplary data change server system embodying the present invention, attention is now directed to FIG. 20 that identifies two functions provided by the I-purge interface 222 of FIG. 4. It is noted, before beginning the description of FIG. 20 that periods are not deleted when purging. The changes are deleted, and the periods are marked as purged. Therefore if, for example, the end time of the highest period is 10:00 a.m. today, then a net change server can not be started using a start time of 8:00 a.m. today. The transactions having a commit time less than 10:00 a.m. will be refused by the store, even if the previously sent data has been purged. When a server needs to process the same transactions multiple times, they must be sent to different stores. Therefore, a user uses a new store when starting a server at some point in time that has previously been processed by the server.

The first of the two functions for the I-purge interface 222 is a purge function 680. The purge function 680 purges (net) change data in stores. Input parameters to the purge function 680 include: a Subscription ID; a Highest Request Number to be Purged; and whether to also clear data for requests that have not yet been read (completely).

An actual purge is not performed if a store is used in one or more other subscriptions, and the request for that subscription has not yet been purged. The requests to be marked as purged are determined by the Highest Request Number to be Purged (input parameter). This request and all previous requests for the same subscription will be marked as purged. For each period the request refers to: if the store is either not used in any other subscription, or the requests of the other subscriptions have all indicated that the period can be purged, the period is actually purged from the store 212. Actual purging means the status of the period is changed to “Purged” and all (net) changes in that period are deleted from the store 212. Furthermore if changes are stored, a period will not be purged if the commit time range of a request does not cover the complete period. Therefore, if the commit time range ends somewhere in the middle of period P, then period P will not actually be purged. Thus, in the exemplary embodiment of the invention, either a period is cleared completely (i.e. all changes are deleted) or it is not cleared at all. It is further noted that a more recent period is not purged until all prior periods have been purged.

The purge function has no output parameters. However, in other embodiments, alternatives include to (1) add the number of requests purged as output parameter, or (2) add the request from/to range purged as output parameter. An exception is rendered in the event that an incorrect subscription ID is provided, and the purge function 680 returns that the identified subscription does not exist.

A purge globally function 682 purges changes associated with identified periods for all clients. Input parameters to the purge globally function 682 include: a Store ID; and a Highest Period to be Purged (note: global purges cannot be based on request numbers, because the request numbers may differ between subscriptions); and whether to clear periods that have not yet been read (completely). The purge globally function 682 is comparable to the Purge function 680. However, the purge globally function 682 purges for all clients. The purge globally function 682 is also used if no subscription exists for a store. The purge globally function 682 marks all requests involved as purged. In all other functions, periods are regarded as something internal, encapsulated by the store. However, for generic management type functions like the purge globally function 682 periods are most useful parameters for delineating the scope of affected changes.

The purge globally function 682 has not output parameters. However, in other embodiments, alternatives include to (1) specify a range of stores instead of a single one, and specify an end commit date/time instead of a highest period, and (2) add output parameters for reporting the result, e.g. number of periods purged. Returned exceptions include: Store ID incorrect.

Illustrative embodiments of the present invention and certain variations thereof have been provided in the Figures and accompanying written description. The present invention is not intended to be limited to these embodiments. Rather the present invention is intended to cover the disclosed embodiments as well as others falling within the scope and spirit of the invention to the fullest extent permitted in view of this disclosure and the inventions defined by the claims appended herein below.

What is claimed is:

1. A method for propagating, by a replication mechanism, changes to a data entry made by a data change source, the method comprising the steps of:
first receiving, by the replication mechanism, a change to a data entry by the data change source;
building, from the change to the data entry, a data change object specifying a first change on an identified data construct;
rendering the data change object available for transmission to at least a data change destination; and
providing the data change object to the data change destination.

2. The method of claim 1 further comprising the step of:
combining the change with other changes within the data change object to render a net change object representing the combined changes.

3. The method of claim 2 wherein the combining step is performed after the building step, and is performed upon the data change object.

4. The method of claim 1 wherein the building step comprises:
inserting, within the data change object, at least one action attribute specifying at least one action performed upon the identified data construct.

5. The method of claim 4 wherein the data change object is a multilevel object structure and wherein the inserting step comprises:
specifying a first action on the data change object at a first level of the data change object; and
specifying a second action on the data change object at a second level of the data change object.

6. The method of claim 5 wherein the data change object comprises a set of tuples, and wherein the first action and second action are specified with reference to individual ones of the tuples.

7. The method of claim 1 further comprising the step of:
applying a filter to the change.

8. The method of claim 1 further comprising the steps of:
retrieving supplementary data; and
incorporating the supplementary data into the data change object.

9. The method of claim 8 further comprising:
synchronizing the change to the data entry and the supplementary data.

10. The method of claim 9, wherein the change to the data entry by the data change source occurs at a first time, T1, and the retrieving supplementary data step occurs at a subsequent time T3, wherein the synchronizing step comprises:
correcting a synchronization inconsistency arising from a transaction executed at a time T2, occurring between the changes at T1 and T3, pertaining to the supplementary data.

11. The method of claim 10 wherein the correcting a synchronization inconsistency step comprises:
reversing a change to the supplementary data arising from the transaction at time T2, and wherein the reversing a change step is performed prior to the rendering step.

12. The method of claim 10 wherein the rendering step is not performed until the server mechanism processes all changes having a potential impact upon the synchronization of the change to the data entry and the supplementary data.

13. The method of claim 12 wherein the rendering step is performed after processing all transactions committed to the database between T1 and T3.

14. The method of claim 10, wherein the correcting a synchronization inconsistency step further comprises the steps of:
placing the data change object in a queue of data change objects based upon execution order of data change transactions; and
de-queuing the data change object when the data change object is at the head of the queue and the correcting a synchronization inconsistency step is complete.

15. The method of claim 9 further comprising the steps of:
applying a first filter to data changes specified in the data change object prior to the synchronizing step; and
applying a second filter to unchanged data specified in the data change object subsequent to the synchronizing step.

16. The method of claim 1 further comprising:
creating a second data change object on a second identified data construct; and
synchronizing the changed data in the data change object and the second data change object.

17. The method of claim 16 wherein the first data change object and second data change object are of different types.

18. The method of claim 1 wherein the building step is performed in response to a notification mechanism activated by the data change source submitting the change to the data entry, thereby facilitating near-real time processing of changes.

19. The method of claim 1 wherein the data change object corresponds to a business entity.

20. The method of claim 1 wherein the data change object is specified using self-identifying data type descriptors.

21. The method of claim 20 wherein the self-identifying data type descriptors comprise XML tags.

22. The method of claim 1 further comprising:
transforming the change to the database entry by the data change source from a first data type to render a data change in a second data type; and
incorporating the data change in the second data type into the data change object.

23. The method of claim 1 further comprising:
reformatting the change to the data entry by the data change source from a first format to render a data change in a second format; and
incorporating the data change in the second format into the data change object.

24. The method of claim 1 wherein the change to the data entry by the data change source is associated with at least a second change within a single data change transaction, and wherein the building step is performed upon both the change and the second change as a single atomic work unit.

25. The method of claim 1 further comprising maintaining a set of data change store state variables to facilitate coordinating storing and retrieving of data change objects from a storage location.

26. The method of claim 25 wherein the rendering step comprises placing the data change object within a data change store that includes a net data change object associated with a period of transactions, and further comprising the step of freezing the period in response to a request to retrieve the data change objects associated with the period of transactions.

27. The method of claim 1 wherein the data change source corresponds to a first application and the data change destination corresponds to a second application.

28. The method of claim 1 wherein the identified data construct is an identified data object.

29. The method of claim 1 wherein the replication mechanism is incorporated into a data replication server.

30. The method of claim 1 wherein the data entry is associated with a database.

31. A computer-readable medium storing computer executable instructions to perform steps for propagating, by a replication mechanism, changes to a data entry made by a data change source, the steps comprising:
first receiving, by the replication mechanism, a change to a data entry by the data change source;
building, from the change to the data entry, a data change object specifying a first change on an identified data construct;
rendering the data change object available for transmission to at least a data change destination; and
providing the data change object to the data change destination.

32. The computer-readable medium of claim 31 wherein the steps further comprise the step of:
combining the change with other changes within the data change object to render a net change object representing the combined changes.

33. The computer-readable medium of claim 31 wherein the building step comprises:
inserting, within the data change object, at least one action attribute specifying at least one action performed upon the identified data construct.

34. The computer-readable medium of claim 33 wherein the identified data construct is a multilevel object structure and wherein the inserting step comprises:
specifying a first action on the data change object at a first level of the data change object; and
specifying a second action on the data change object at a second level of the data change object.

35. The computer-readable medium of claim 31 wherein the steps further comprise the step of:
applying a filter to the change.

36. The computer-readable medium of claim 31 wherein the steps further comprise:
retrieving supplementary data; and
incorporating the supplementary data into the data change object.

37. The computer-readable medium of claim 36 wherein the steps further comprise:
synchronizing the change to the data entry and the supplementary data.

38. The computer-readable medium of claim 37 wherein the change to the data entry by the data change source occurs at a first time, T1, and the retrieving supplementary data step occurs at a subsequent time T3, and wherein the synchronizing step comprises:
correcting a synchronization inconsistency arising from a transaction executed at a time T2, occurring between the changes at T1 and T3, pertaining to the supplementary data.

39. The computer-readable medium of claim 38 wherein the synchronizing step further comprises:
reversing a change to the supplementary data arising from the transaction at time T2, and wherein the reversing a change step is performed prior to the rendering step.

40. The computer-readable medium of claim 38 wherein the rendering step is not performed until the server mechanism processes all changes having a potential impact upon the synchronization of the change to the data entry and the supplementary data.

41. The computer-readable medium of claim 40 wherein the rendering step is performed after processing all transactions committed to the database between T1 and T3.

42. The computer-readable medium of claim 38 wherein the synchronizing inconsistencies step further comprises the steps of:
placing the data change object in a queue of data change objects based upon execution order of data change transactions; and
de-queuing the data change object when the data change object is at the head of the queue and the correcting a synchronization inconsistency step is complete.

43. The computer-readable medium of claim 37 wherein the steps further comprise:
applying a first filter to data changes specified in the data change object prior to the synchronizing step; and
applying a second filter to unchanged data specified in the data change object subsequent to the synchronizing step.

44. The computer-readable medium of claim 31 wherein the steps further comprise:
creating a second data change object on a second identified data construct; and
synchronizing the changed data in the data change object and the second data change object.

45. The computer-readable medium of claim 44 wherein the first data change object and second data change object are of different types.

46. The computer-readable medium of claim 31 wherein the building step is performed in response to a notification mechanism activated by the data change source submitting the change to the data entry, thereby facilitating near-real time processing of changes.

47. The computer-readable medium of claim 31 wherein the data change object is specified using self-identifying data type descriptors.

48. The computer-readable medium of claim 31 wherein the steps further comprise:
transforming the change to the data entry by the data change source from a first data type to render a data change in a second data type; and
incorporating the data change in the second data type into the data change object.

49. The computer-readable medium of claim 31 wherein the steps further comprise:
reformatting the change to the data entry by the data change source from a first format to render a data change in a second format; and
incorporating the data change in the second format into the data change object.

50. The computer-readable medium of claim 31 wherein the change to the data entry by the data change source is associated with at least a second change within a single data change transaction, and wherein the building step is performed upon both the change and the second change as a single atomic work unit.

51. The computer-readable medium of claim 31 wherein the steps further comprise:
maintaining a set of data change store state variables to facilitate coordinating storing and retrieving of data change objects from a storage location.

52. The computer-readable medium of claim 51 wherein the rendering step comprises placing the data change object within a data change store that includes a net data change object associated with a period of transactions, and further comprising the step of freezing the period in response to a request to retrieve the data change objects associated with the period of transactions.

53. The computer-readable medium of claim 31 wherein the data change source corresponds to a first application and the data change destination corresponds to a second application.

54. The computer-readable medium of claim 31 wherein the identified data construct is an identified data object.

55. The computer-readable medium of claim 31 wherein the replication mechanism is incorporated into a data replication server.

56. The computer-readable medium of claim 31 wherein the data entry is associated with a database.

57. A data change system for propagating changes to a data entry made by a data change source, the change server system comprising:
a data change input interface for first receiving a change to a data entry by the data change source;
a data change processor for building, from the change to the data entry, a data change object specifying a first change on an identified data construct, and rendering the data change object available for transmission to at least a data change destination; and
a data change object output interface for providing the data change object to the data change destination.

58. The data change system of claim 57 wherein the data change processor further includes a functional component for combining the change with other changes within the data change object to render a net change object representing the combined changes.

59. The data change system of claim 57 wherein the data change objects include multilevel object structures specifying a first action on the data change object at a first level of the data change object, and specifying a second action on the data change object at a second level of the data change object.

60. The data change system of claim 57 wherein the data change system incorporates configurable filtering functions.

61. The data change system of claim 60 wherein the filtering functions are facilitated by DLLs.

62. The data change system of claim 57 wherein the data change processor comprises a data change object buffer facilitating synchronizing the change to the data entry and supplementary data.

63. The data change system of claim 62 wherein the data change object buffer comprises a queue, and wherein the queue is managed within the data change processor to place the data change object in a queue of data change objects based upon execution order of data change transactions; and de-queuing the data change object when the data change object is at the head of the queue and the incorporating step is complete.

64. The data change system of claim 62 wherein the data change processor comprises a multi-stage filter including:
a first filter stage for applying a first filter to data changes specified in the data change object prior to the synchronizing step; and
a second filter stage for applying a second filter to unchanged data specified in the data change object subsequent to the synchronizing step.

65. The data change system of claim 57 wherein the data change object is specified using self-identifying data type descriptors.

66. The data change system of claim 57 wherein the data change processor includes a postprocessor for transforming the change to the data entry by the data change source from a first data type to render a data change in a second data type, and incorporating the data change in the second data type into the data change object.

67. The data change system of claim 57 wherein the data change processor includes a postprocessor for reformatting the change to the data entry by the data change source from a first format to render a data change in a second format, and incorporating the data change in the second format into the data change object.

68. The data change system of claim 57 wherein the data change processor includes for a set of data change store state variables to facilitate coordinating storing and retrieving of data change objects from a storage location.

69. The data change system of claim 68 wherein the set of data change store state variables includes a freeze variable for freezing a period thereby foreclosing adding further data change objects, after a point corresponding to the freeze variable, to a set of changes associated with the period.

70. The data change system of claim 57 wherein the data change object includes:
a first tagged field identifying the object type for the identified data object; and
a second tagged field identifying a new value for the identified data object.

71. The data change system of claim 70 wherein the data change object includes:
a third tagged field identifying an action on the identified data object;
a fourth tagged field identifying an old value for the identified data object.

72. The data change system of claim 71 wherein the possible values for the third tagged field include values corresponding to inserting, updating and deleting at least a specified part of the identified data object.

73. The data change system of claim 57 wherein the data change source corresponds to a first application and the data change destination corresponds to a second application.

74. The data change system of claim 57 wherein the identified data construct is an identified data object.

75. The data change system of claim 57 wherein the data change processor is incorporated into a data replication server.

76. The data change system of claim 57 wherein the data entry is associated with a database.
